(19) United States
(12) Patent Application Publication
(10) Pub. No.: US 2026/0291103 A1
(43) Pub. Date: Sep. 24, 2026

(54) FEMALE TERMINAL AND CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Yusuke YAMADA, Mie (JP); Katsuhiko AIZAWA, Mie (JP); Tomohiro HAYASHI, Mie (JP); Takato MIZUNO, Mie (JP)

(21) Appl. No.: 19/490,945

(22) PCT Filed: Jun. 5, 2024
(86) PCT No.: PCT/JP2024/020450

§ 371 Date: Dec. 8, 2025

(30) Foreign Application Priority Data
Jun. 9, 2023 (JP) 2023-095641

(51) Int. Cl. H01R 13/11

(52) U.S. Cl. CPC H01R 13/111

(57) ABSTRACT

A female terminal includes a peripheral wall having a tubular portion, a peripheral wall having a tubular portion facing the tubular portion, and a tubular connecting portion composed of the tubular portion and the tubular portion. The tubular connecting portion is a connecting portion, into which a columnar connecting portion of a male terminal is inserted and which is electrically connected to the columnar connecting portion. The tubular portion includes a plurality of divided tubular portions divided in an axial direction of the tubular connecting portion. Each of the plurality of divided tubular portions includes an inner surface facing the tubular portion and a protrusion arcuately projecting radially inwardly of the tubular portion from the inner surface in a cross-section.

### TECHNICAL FIELD

The present disclosure relates to a female terminal and a connector.

### BACKGROUND

Conventionally, a connector provided with a housing and a female terminal held in the housing has been known as a connector to be installed in a vehicle. A columnar connecting portion of a male terminal is inserted into and electrically connected to a tubular connecting portion of the female terminal. The female terminal of this type stably ensures a contact pressure with the columnar connecting portion of the male terminal, utilizing a biasing force by a biasing member such as a coil spring (see, for example, Patent Document 1).

### PRIOR ART DOCUMENT

### Patent Document

Patent Document 1: JP 2021-028903 A

### SUMMARY OF THE INVENTION

### Problems to Be Solved

In the above connector, it is desired to suppress a displacement of the columnar connecting portion inside the tubular connecting portion.

The present disclosure aims to provide a female terminal and a connector capable of suppressing a displacement of a columnar connecting portion inside a tubular connecting portion.

### Means to Solve the Problem

The present disclosure is directed to a female terminal with a first peripheral wall having a first tubular portion, a second peripheral wall having a second tubular portion facing the first tubular portion, and a tubular connecting portion composed of the first tubular portion and the second tubular portion, the tubular connecting portion being a first connecting portion, a columnar connecting portion of a male terminal being inserted into the first connecting portion, the first connecting portion being electrically connected to the columnar connecting portion, the first tubular portion including a plurality of divided tubular portions divided in an axial direction of the tubular connecting portion, and each of the plurality of divided tubular portions including a first inner surface facing the second tubular portion and a protrusion arcuately projecting radially inwardly of the tubular portion from the first inner surface in a cross-section.

### Effect of the Invention

According to the female terminal and the connector of the present disclosure, an effect of being able to suppress a displacement of the columnar connecting portion inside the tubular connecting portion is achieved.

### BRIEF DESCRIPTION OF THE DRAWINGS

FIG. 1 is a perspective view showing a wiring harness of one embodiment.

FIG. 2 is an exploded perspective view showing the wiring harness of the embodiment.

FIG. 3 is an exploded perspective view showing the wiring harness of the embodiment.

FIG. 4 is a perspective view showing a part of the wiring harness of the embodiment.

FIG. 5 is a plan view showing the part of the wiring harness of the embodiment.

FIG. 6 is a plan view showing the part of the wiring harness of the embodiment.

FIG. 7 is a section showing a part of the wiring harness of the embodiment (section along 7-7 in FIGS. 5 and 6).

FIG. 8 is a section showing a part of the wiring harness of the embodiment (section along 8-8 in FIGS. 5 and 6).

FIG. 9 is a plan view showing a female terminal of the embodiment.

FIG. 10 is a perspective view in section showing the female terminal of the embodiment.

FIG. 11 is a section showing the female terminal of the embodiment (section along 11-11 in FIGS. 5 and 6).

FIG. 12 is a section showing the female terminal of the embodiment (section along 12-12 in FIG. 11).

FIG. 13 is perspective view in section showing the female terminal of the embodiment.

FIG. 14 is an exploded perspective view showing a part of the wiring harness of the embodiment.

FIG. 15 is a plan view showing a part of the wiring harness of the embodiment. FIG. 16 is a section showing a part of the wiring harness of the embodiment (section along 16-16 in FIG. 15).

### DETAILED DESCRIPTION TO EXECUTE THE INVENTION

### Description of Embodiments of Present Disclosure

First, embodiments of the present disclosure are listed and described.
[1] The female terminal of the present disclosure is provided with a first peripheral wall having a first tubular portion, a second peripheral wall having a second tubular portion facing the first tubular portion, and a tubular connecting portion composed of the first tubular portion and the second tubular portion, the tubular connecting portion being a first connecting portion, a columnar connecting portion of a male terminal being inserted into the first connecting portion, the first connecting portion being electrically connected to the columnar connecting portion, the first tubular portion including a plurality of divided tubular portions divided in an axial direction of the tubular connecting portion, and each of the plurality of divided tubular portions including a first inner surface facing the second tubular portion and a protrusion arcuately projecting radially inwardly of the tubular portion from the first inner surface in a cross-section.

According to this configuration, when the columnar connecting portion of the male terminal is press-fit into the tubular connecting portion, the protrusion provided on the first inner surface of each of the plurality of divided tubular portions is brought into contact with the outer peripheral surface of the columnar connecting portion. Thus, in the tubular connecting portion, the plurality of protrusions are brought into contact with the outer peripheral surface of the columnar connecting portion at a plurality of positions separated in the axial direction. In this way, for example, even if a swinging movement is transmitted to the male terminal, a displacement of the male terminal due to that swinging movement can be suitably hindered by the contact of the plurality of protrusions with the columnar connecting portion. That is, the displacement of the columnar connecting portion inside the tubular connecting portion can be suppressed by contact pressures by the plurality of protrusions as compared to the case where only one protrusion is provided on the inner surface of the first tubular portion.
[2] In [1] described above, the plurality of divided tubular portions may be two divided tubular portions, the first tubular portion may include a slit dividing the two divided tubular portions, and the slit may be provided at a center position of the tubular portion in the axial direction.

According to this configuration, the slit dividing the two divided tubular portions is provided at a center in the axial direction of the tubular connecting portion. At this time, when the columnar connecting portion of the male terminal inserted into the tubular connecting portion is displaced, the columnar connecting portion rotates with the center in the axial direction of the tubular connecting portion as a center of rotation. If a contact part of the protrusion and the columnar connecting portion is provided at such a center of rotation, a contact pressure by the protrusion cannot be exerted as a force for suppressing a displacement of the columnar connecting portion. In contrast, in the above configuration, the protrusion is provided at a position different from the slit provided at the center in the axial direction of the tubular connecting portion. Thus, the protrusion and the tubular connecting portion can be brought into contact at the position different from the center of rotation in the displacement of the columnar connecting portion. In this way, the contact pressure by the protrusion can be suitably exerted as a force for suppressing the displacement of the columnar connecting portion. As a result, the displacement of the columnar connecting portion inside the tubular connecting portion can be suitably suppressed by the contact pressures by the plurality of protrusions.
[3] In [2] described above, the first peripheral wall may be formed into a strip shape extending along a first direction, the second peripheral wall may be formed into a strip shape extending along the first direction, the first inner surface may be provided to face the second tubular portion in a second direction intersecting the first direction, the axial direction of the tubular connecting portion may extend along a third direction intersecting both the first direction and the second direction, the slit may extend along a first opposite direction opposite to the first direction from an end surface in the first direction of the first peripheral wall, the slit may penetrate through the first peripheral wall in both the second direction and a second opposite direction opposite to the second opposite direction, and the slit may be open in the first direction.

According to this configuration, the end part in the first direction of the first peripheral wall including the first tubular portion is formed into a structure formed by the slit. Thus, the two divided tubular portions are formed into structures independent of each other. In this way, the contact pressures with the columnar connecting portion of the male terminal can be respectively independently ensured by the two divided tubular portions.
[4] In [3] described above, the two divided tubular portions may be plane-symmetrically formed with respect to a virtual plane including a center of the slit in the third direction and extending in both the first direction and the first opposite direction.

According to this configuration, the two divided tubular portions are plane-symmetrically formed. Thus, the contact pressures equal to each other can be ensured at the two divided tubular portions provided on both sides of the slit.
[5] In [4] described above, a projecting tip of the protrusion of each of the two divided tubular portions may be provided at a position separated from a center of the tubular connecting portion in the axial direction by a first distance in the axial direction.

According to this configuration, the projecting tip of each protrusion is provided at the position separated from the center in the axial direction of the tubular connecting portion by the first distance. Thus, the projecting tip of the protrusion and the columnar connecting portion can be brought into contact at the position separated from the center of rotation in the displacement of the columnar connecting portion by the first distance. In this way, the contact pressure by the protrusion can be suitably exerted as a force for suppressing the displacement of the columnar connecting portion. As a result, the displacement of the columnar connecting portion inside the tubular connecting portion can be suitably suppressed by the contact pressures by the plurality of protrusions.
[6] In any one of [1] to [5] described above, the second tubular portion may include a second inner surface facing the first inner surface and a plurality of linear contact portions projecting radially inwardly of the tubular connecting portion from the second inner surface, the plurality of linear contact portions may be provided at positions separated from each other in a circumferential direction of the tubular connecting portion, and each of the plurality of linear contact portions may extend along the axial direction.

According to this configuration, when the columnar connecting portion of the male terminal is press-fit into the tubular connecting portion, the linear contact portions provided on the second inner surface constituting the tubular connecting portion are pressed into line contact with the outer peripheral surface of the columnar connecting portion at a plurality of positions separated in the circumferential direction. In this way, for example, even if a swinging movement is transmitted to the male terminal, the displacement of the male terminal due to that swinging movement can be suitably hindered by the contact of the plurality of linear contact portions with the male terminal.
[7] In [6] described above, the female terminal may be provided with a winding/pressing portion for limiting a separation distance between the first inner surface and the second inner surface, the winding/pressing portion may be integrally formed to the second peripheral wall, and the winding/pressing portion may be folded from the second peripheral wall while embracing an end edge of the first peripheral wall inside, and held in contact with an outer surface of the first peripheral wall.

According to this configuration, when the columnar connecting portion of the male terminal is press-fit into the tubular connecting portion, an increase in separation distance between the first inner surface constituting the tubular connecting portion and the second inner surface constituting the tubular connecting portion is limited by the winding/pressing portion. By this limitation by the winding/pressing portion, the protrusion and the linear contact portions can be suitably brought into contact with the outer peripheral surface of the columnar connecting portion. As a result, a contact state of the tubular connecting portion and the columnar connecting portion can be stably held. Further, the winding/pressing portion is integrally formed to the second peripheral wall. Thus, the contact state of the tubular connecting portion and the columnar connecting portion can be held by a simple structure as compared to the case where a separate component such as a coil spring is used. That is, the structure of the female terminal can be simplified as compared to the case where a separate component such as a coil spring is used.
[8] In [7] described above, the female terminal may be further provided with a coupling portion coupling the first peripheral wall and the second peripheral wall, and the coupling portion may be integrally formed to the first peripheral wall and integrally formed to the second peripheral wall.

According to this configuration, the first and second peripheral walls are coupled by the coupling portion integrally formed to the both first and second peripheral walls. In this way, the first and second peripheral walls can be integrally formed through the coupling portion. Thus, the female terminal can be configured, such as by bending one metal plate. As a result, the structure of the female terminal can be simplified.
[9] In [8] described above, the first peripheral wall may be formed into a strip shape extending along a first direction, the second peripheral wall may be formed into a strip shape extending along the first direction, the first inner surface may be provided to face the second tubular portion in a second direction intersecting the first direction, the female terminal may be further provided with a protecting portion provided on an end part in the first direction of the second peripheral wall, the protecting portion may be integrally formed to the second peripheral wall, the protecting portion may be formed to be folded from the end part in the first direction of the second peripheral wall while arranging an end part in the first direction of the first peripheral wall inside, the protecting portion may include a protection wall provided to face the end part in the first direction of the first peripheral wall in the second direction, and the protection wall may be provided away from the end part in the first direction of the first peripheral wall.

According to this configuration, the protection wall of the protecting portion integrally formed to the second peripheral wall is provided to face the end part in the first direction of the first peripheral wall while being separated therefrom. Thus, the deformation of the first peripheral wall can be suitably hindered by the protection wall, for example, even if an excessive external force is accidentally applied to the end part in the first direction of the first peripheral wall and the first peripheral wall is deformed away from the second peripheral wall due to that external force.
[10] In [9] described above, the winding/pressing portion may be provided on an end part in a first opposite direction opposite to the first direction, out of the second peripheral wall, and the tubular connecting portion may be provided at an intermediate position between the winding/pressing portion and the protecting portion in the first direction.

According to this configuration, the winding/pressing portion is provided at a position different from the tubular connecting portion in the first direction. An increase in separation distance between the first and second peripheral walls can be limited by such a winding/pressing portion. Consequently, an increase in separation distance between the first inner surface constituting the tubular connecting portion and the second inner surface constituting the tubular connecting portion can be limited by the winding/pressing portion.
[11] In [9] or [10] described above, the female terminal may be further provided with a wire connecting portion provided on an end part in a first opposite direction opposite to the first direction, out of the second peripheral wall, the wire connecting portion may be a second connecting portion to be electrically connected to a wire, the wire connecting portion may be integrally formed to the second peripheral wall, and the wire connecting portion may extend in the first opposite direction from the end part in the first opposite direction of the second peripheral wall.

According to this configuration, the wire connecting portion to be electrically connected to the wire is integrally formed to the second peripheral wall. Thus, the number of components of the female terminal can be reduced, and the structure of the female terminal can be simplified.
[12] A connector of the present disclosure is provided with the female terminal of any one of [1] to [11] described above, and a housing for accommodating the female terminal inside.

According to this configuration, effects similar to those of the female terminal of [1] described above can be obtained.

### DETAILS OF EMBODIMENT OF PRESENT DISCLOSURE

Specific examples of a female terminal and a connector of the present disclosure are described below with reference to the drawings. For the convenience of description, some components may be shown in an exaggerated or simplified manner in each drawing. Further, a dimension ratio of each part may be different in each figure. “Parallel” and “orthogonal” in this specification mean not only strictly parallel and orthogonal, but also substantially parallel and orthogonal within a range in which functions and effects in this embodiment are achieved. In this specification, a term “equal” also means a case where objects to be compared are slightly different due to dimensional tolerances and the like, in addition to meaning exactly equal. A term “tubular” used in the description of this specification indicates not only a shape formed by a peripheral wall continuous over an entire periphery in a circumferential direction, but also a shape formed by combining a plurality of components and a shape having a cut or the like in a circumferential part such as a C shape and a U shape. Note that “tubular” shapes include circular shapes, elliptical shapes and polygonal shapes with angular or round corners, but there is no limitation to these. “Facing each other” in this specification indicates that surfaces or members are at positions in front of each other, and means not only a case where the surfaces or members are at positions perfectly in front of each other, but also a case where the surfaces or members are partially in front of each other. Further, “facing each other” in this specification means both a case where another member different from two parts is interposed between the two parts and a case where nothing is interposed between the two parts. Further, terms such as “first”, “second” and “third” in this specification are merely used to distinguish objects and do not rank the objects. Note that the present invention is not limited to these illustrations, but is represented by claims and intended to include all changes in the scope of claims and in the meaning and scope of equivalents.

### Overall Configuration of Wiring Harness W1

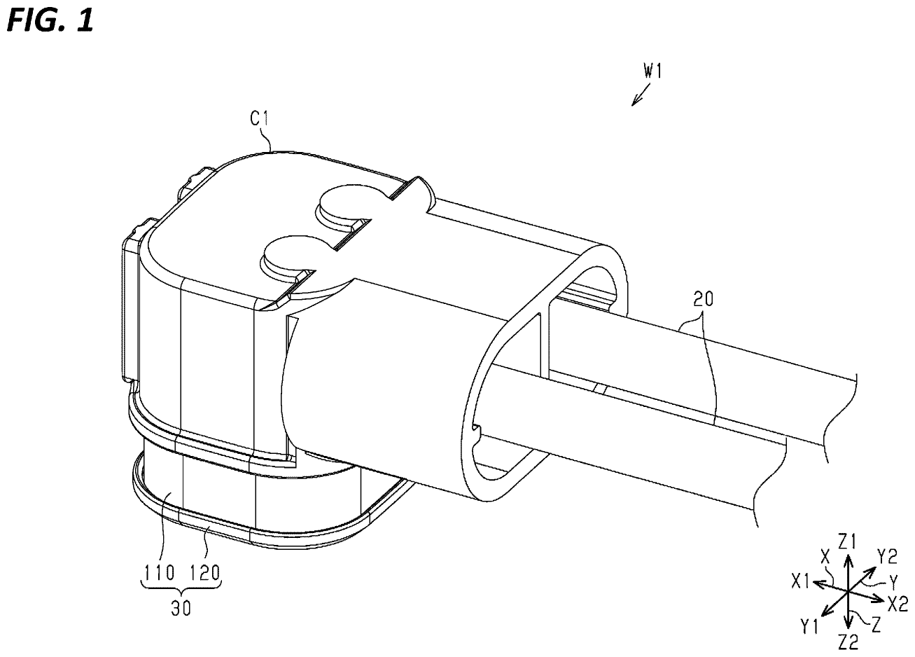

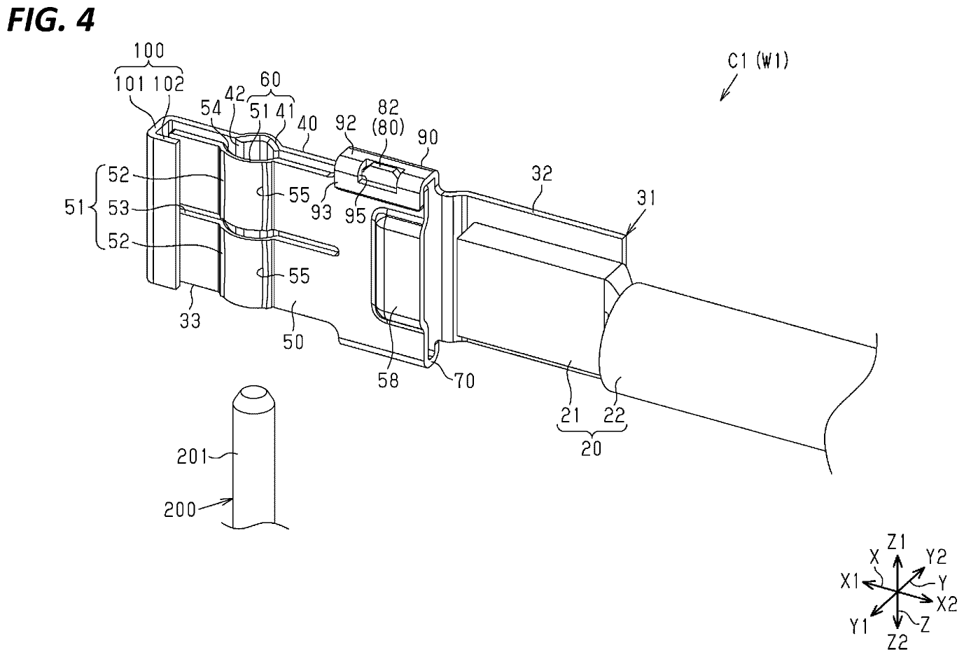

As shown in FIG. 1, a wiring harness W1 is provided with one or more (two in this embodiment) wires 20 and a connector C1 mounted on end parts of the wires 20. The wiring harness W1 is, for example, for electrically connecting electrical devices for vehicle. An inverter and a wheel drive motor can be, for example, cited as the electrical devices for vehicle. Although not shown in detail, the connector C1 is electrically connected to a mating connector provided on the electrical device. The mating connector is provided with one or more (two in this embodiment) male terminals 200 as mating terminals (see FIG. 4) and a mating housing for holding the two male terminals 200. Note that respective directions in each figure do not necessarily indicate the postures of the connector C1 and the wiring harness W1 during usage.

### Overall Configuration of Connector C1

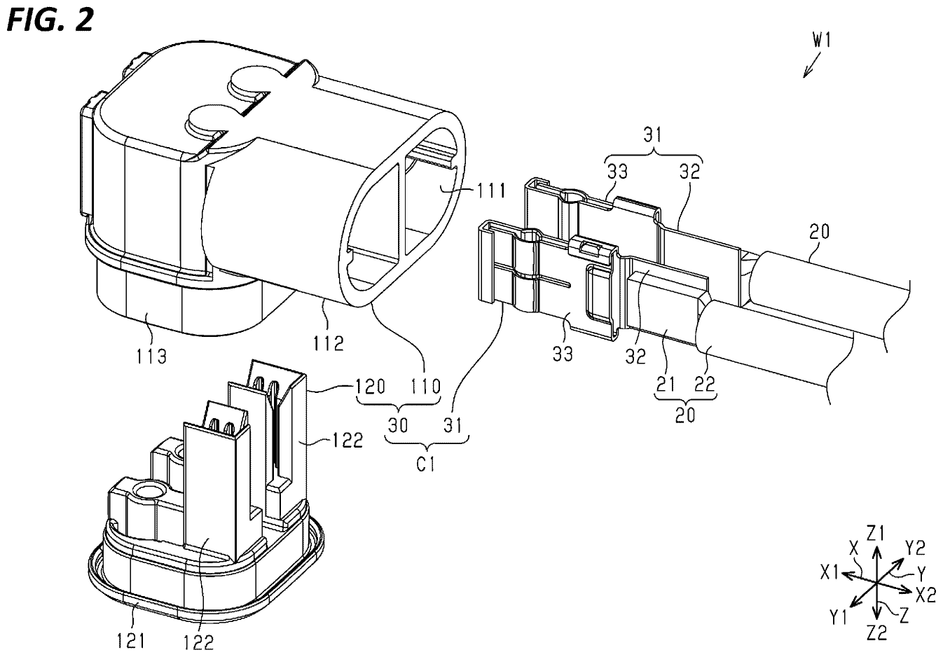

As shown in FIG. 2, the connector C1 is provided with a housing 30 and a plurality of female terminals 31 respectively connected to end parts of a plurality of wires 20. The housing 30 holds a plurality of the female terminals 31. The housing 30 includes a housing body 110 for accommodating the female terminals 31 inside and a retainer 120 to be mounted into the housing body 110. Note that an X axis, a Y axis and a Z axis orthogonal to each other are shown in each figure. In each figure, a first direction X1, which is one of X-axis directions along the X axis, and a first opposite direction X2, which is a direction opposite to the first direction X1, are shown. In each figure, a second direction Y1, which is one of Y-axis directions along the Y axis, and a second opposite direction Y2, which is a direction opposite to the second direction Y1, are shown. In each figure, a third direction Z1, which is one of Z-axis directions along the Z axis, and a third opposite direction Z2, which is a direction opposite to the third direction Z1, are shown. Each direction described above is a direction in a state where the connector C1 is mounted on the end parts of the wires 20 unless otherwise specified.

The female terminals 31 and the wires 20 are inserted into the housing body 110 along the first direction X1. The retainer 120 is mounted into the housing body 110 along the third direction Z1. The mating connector is connected to the connector C1, for example, along the third direction Z1. For example, the male terminals 200 (see FIG. 4) of the mating connector are inserted into the housing body 110 along the third direction Z1.

### Configuration of Wire 20

Each wire 20 includes an electrically conductive core wire 21 and an insulating insulation coating 22 surrounding the outer periphery of the core wire 21. A stranded wire formed by twisting a plurality of metal strands or a single core wire constituted by a single conductor can be, for example, used as the core wire 21. The insulation coating 22 covers, for example, the outer peripheral surface of the core wire 21 over the entire periphery in a circumferential direction.

An end part in the first direction X1 of the core wire 21 is exposed from the insulation coating 22. The female terminal 31 is connected to the end part in the first direction X1 of the core wire 21 exposed from the insulation coating 22.

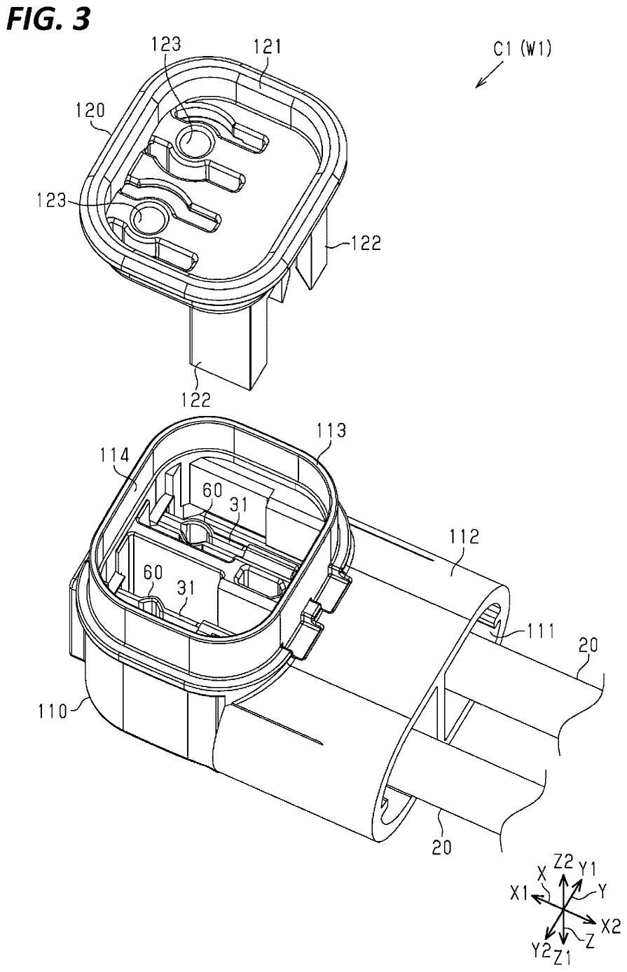

As shown in FIG. 3, an end part in the first direction X1 of the wire 20 is accommodated inside the housing body 110. The wire 20 is drawn out in the first opposite direction X2 from an end part in the first opposite direction X2 of the housing body 110.

### Configuration of Female Terminals 31

As shown in FIG. 2, the two female terminals 31 are respectively electrically connected to the two wires 20. The two female terminals 31 are provided side by side along the Y-axis direction. The two female terminals 31 have, for example, the same structure. Here, description is given, focusing on the female terminal 31 provided on the second direction Y1 side, out of the two female terminals 31.

Each female terminal 31 includes a wire connecting portion 32 to be connected to the end part of the wire 20 and a terminal connecting portion 33 extending in the first direction X1 from an end part in the first direction X1 of the wire connecting portion 32. Each female terminal 31 is, for example, a single component in which the wire connecting portion 32 and the terminal connecting portion 33 are continuously and integrally formed. Each female terminal 31 is configured, for example, by bending a metal plate material or combining metal plate materials. Each female terminal 31 of this embodiment is configured by bending one metal plate material. Each female terminal 31 is, for example, made of metal. A copper-based or aluminum-based metal material can be, for example, used as a material of each female terminal 31.

The wire connecting portion 32 is connected to the end part of the core wire 21 exposed from the insulation coating 22. The wire connecting portion 32 is, for example, in the form of a flat plate. The wire connecting portion 32 is, for example, in the form of a stipe extending along the X-axis direction. The wire connecting portion 32 is, for example, connected to the core wire 21 by crimping, ultrasonic welding or the like. In this way, the wire connecting portion 32 and the core wire 21 are electrically and mechanically connected.

As shown in FIG. 4, the terminal connecting portion 33 is a female terminal portion to be connected to the male terminal 200 of the mating connector. Here, the male terminal 200 includes a column-like columnar connecting portion 201. The columnar connecting portion 201 of this embodiment is formed into a cylindrical shape.

The terminal connecting portion 33 includes a peripheral wall 40 having a tubular portion 41, a peripheral wall 50 having a tubular portion 51 facing the tubular portion 41 and a tubular connecting portion 60. The terminal connecting portion 33 includes, for example, a coupling portion 70, a projecting portion 80, a winding/pressing portion 90 and a protecting portion 100. The peripheral walls 40, 50 are facing each other in the Y-axis direction.

### Configurations of Peripheral Wall 40 and Peripheral Wall 50

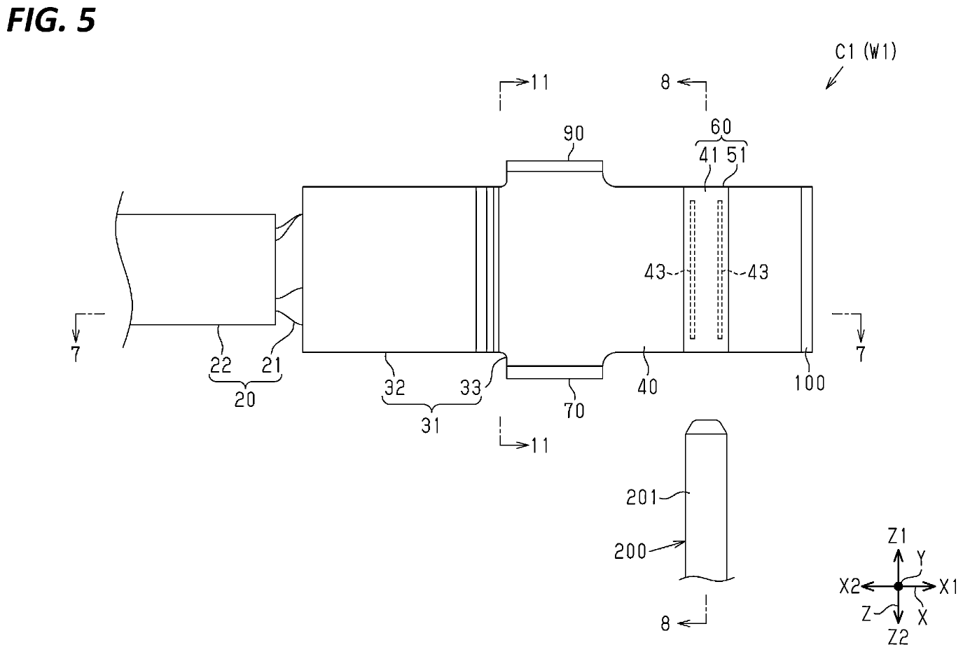

As shown in FIGS. 4 and 5, an end part in the first opposite direction X2 of the peripheral wall 40 is connected to the end part in the first direction X1 of the wire connecting portion 32. The peripheral wall 40 is in the form of a strip extending along the first direction X1. The peripheral wall 40 extends, for example, in the first direction X1 from the end part in the first direction X1 of the wire connecting portion 32. In other words, the wire connecting portion 32 extends in the first opposite direction X2 from an end part in the first opposite direction X2 of the peripheral wall 40. The peripheral wall 40 is, for example, in the form of a flat plate. The peripheral wall 40 has a predetermined width along the Z-axis direction. As shown in FIG. 4, the peripheral wall 40 has a predetermined thickness along the Y-axis direction. The peripheral wall 40 has an inner surface facing the peripheral wall 50 and an outer surface provided on a side opposite to the inner surface in the Y-axis direction.

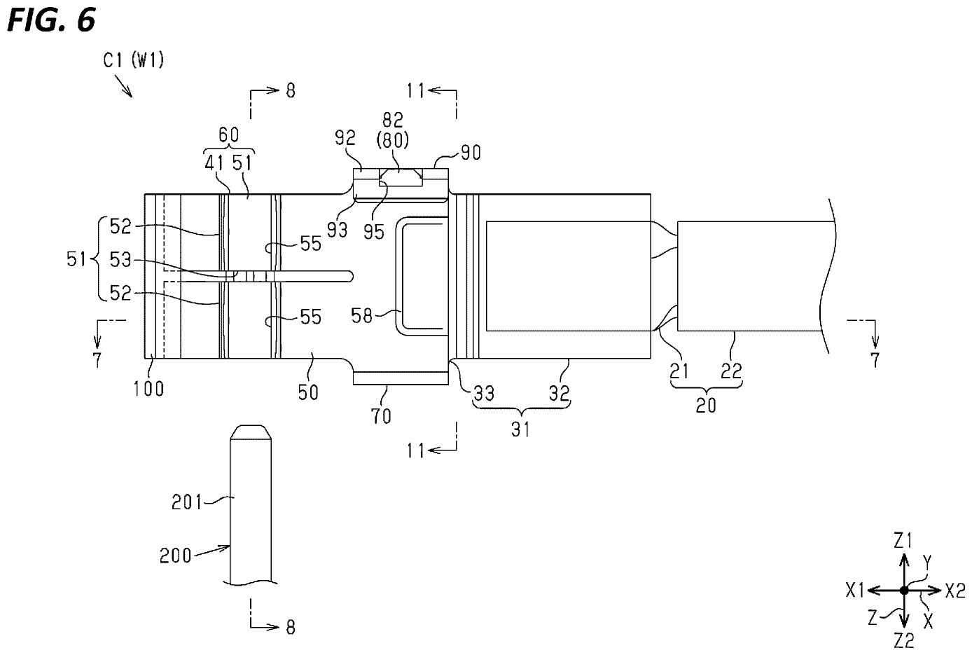

As shown in FIGS. 4 and 6, the peripheral wall 50 is in the form of a strip extending along the first direction X1. The peripheral wall 50 is, for example, in the form of a flat plate. The peripheral wall 50 has a predetermined width along the Z-axis direction. As shown in FIG. 4, the peripheral wall 50 has a predetermined thickness along the Y-axis direction. The peripheral wall 50 has an inner surface facing the inner surface of the peripheral wall 40 and an outer surface provided on a side opposite to the inner surface in the Y-axis direction. The inner surface of the peripheral wall 50 is, for example, provided away from the inner surface of the peripheral wall 40 in the Y-axis direction. The peripheral wall 50 extends, for example, in parallel to the peripheral wall 40.

The tubular portion 41 is provided at an intermediate position in the X-axis direction of the peripheral wall 40. The tubular portion 41 is provided between the winding/pressing portion 90 and the protecting portion 100 in the X-axis direction. The tubular portion 41 is, for example, formed into a half tube shape as a whole. As shown in FIG. 5, the tubular portion 41 extends along the Z-axis direction. The tubular portion 41 extends over the entire length in the Z-axis direction of the peripheral wall 40.

As shown in FIG. 4, the tubular portion 51 is provided at an intermediate position in the X-axis direction of the peripheral wall 50. The tubular portion 51 is provided between the winding/pressing portion 90 and the protecting portion 100 in the X-axis direction. The tubular portion 51 is, for example, formed into a half tube shape as a whole. The tubular portion 51 extends along the Z-axis direction. The tubular portion 51 extends over the entire length in the Z-axis direction of the peripheral wall 50.

The tubular portions 41, 51 are curved in directions separating from each other. The tubular connecting portion 60 is constituted by the tubular portions 41, 51. The tubular connecting portion 60 is a connecting part, into which the columnar connecting portion 201 of the male terminal 200 is inserted and which is electrically connected to the columnar connecting portion 201. An axial direction of the tubular connecting portion 60 is a direction intersecting an extension direction of the peripheral walls 40, 50 (here, the X-axis direction) and, in this embodiment, extends along the Z-axis direction. The tubular connecting portion 60 is open on both ends in the Z-axis direction. The columnar connecting portion 201 is inserted into the tubular connecting portion 60 of this embodiment along the third direction Z1.

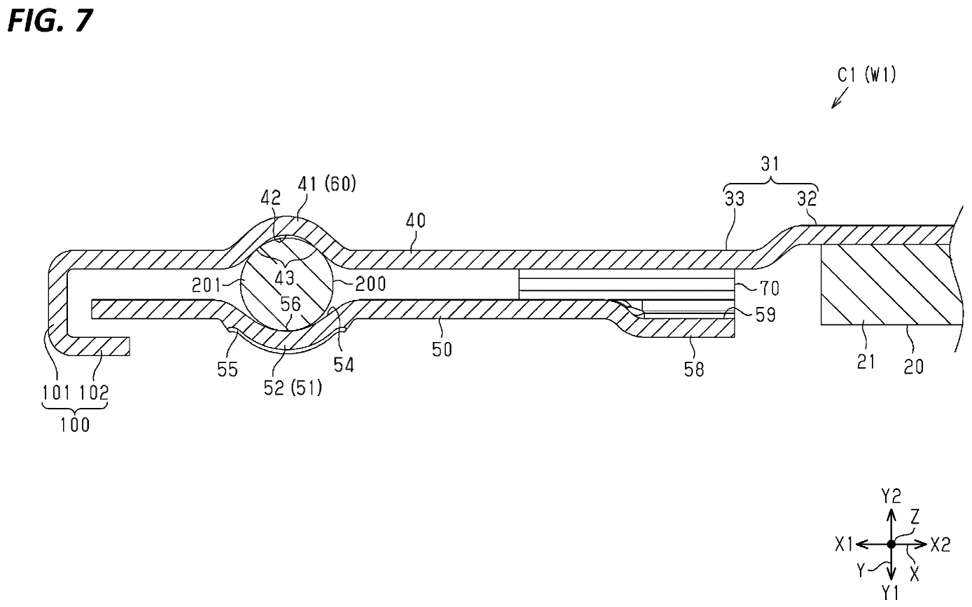

As shown in FIG. 7, the tubular connecting portion 60 is, for example, formed into a hollow cylindrical portion as a whole. The tubular connecting portion 60 has, for example, a minimum inner diameter smaller than a maximum outer diameter of the columnar connecting portion 201. That is, the tubular connecting portion 60 is so configured that the columnar connecting portion 201 is press-fit thereinto.

The tubular portion 41 has an inner surface 42 facing in the second direction Y1 and an outer surface provided on a side opposite to the inner surface 42. The outer surface of the tubular portion 41 is formed into a curved surface having an arcuate cross-sectional shape obtained by cutting the tubular portion 41 by a plane parallel to the X-axis direction. The outer surface of the tubular portion 41 is formed to arcuately project radially outwardly of the tubular connecting portion 60 in a cross-section. Similarly, the inner surface 42 of the tubular portion 41 is formed to be arcuately recessed radially outwardly of the tubular connecting portion 60 in a cross-section.

The inner surface 42 of the tubular portion 41 is provided with a plurality of (two in this embodiment) linear contact portions 43 projecting radially inwardly of the tubular connecting portion 60 from the inner surface 42. The two linear contact portions 43 are provided at positions separated from each other in a circumferential direction of the tubular connecting portion 60. The two linear contact portions 43 are, for example, provided to partially face each other in the X-axis direction. As shown in FIG. 5, each linear contact portion 43 extends along the axial direction of the tubular connecting portion 60 (here, the Z-axis direction).

As shown in FIG. 7, a curvature of the inner surface 42 having the two linear contact portions 43 is set to be smaller than that of the outer peripheral surface of the columnar connecting portion 201 of the male terminal 200. In this way, the two linear contact portions 43 can be suitably brought into contact with the outer peripheral surface of the columnar connecting portion 201. At this time, each linear contact portion 43 is linearly held in contact with the outer peripheral surface of the columnar connecting portion 201 along the axial direction of the tubular connecting portion 60. That is, each linear contact portion 43 linearly contacts the outer peripheral surface of the columnar connecting portion 201.

As shown in FIG. 6, the tubular portion 51 includes a plurality of (two in this embodiment) divided tubular portions 52 divided in the axial direction of the tubular connecting portion 60 and a slit 53 dividing the two divided tubular portions 52. The two divided tubular portions 52 are provided away from each other across the slit 53 in the axial direction of the tubular connecting portion 60. The two divided tubular portions 52 have, for example, the same structure. The two divided tubular portions 52 are, for example, plane-symmetrically formed with respect to a virtual plane including a center of the slit 53 in the Z-axis direction and extending in both the first direction X1 and the first opposite direction X2.

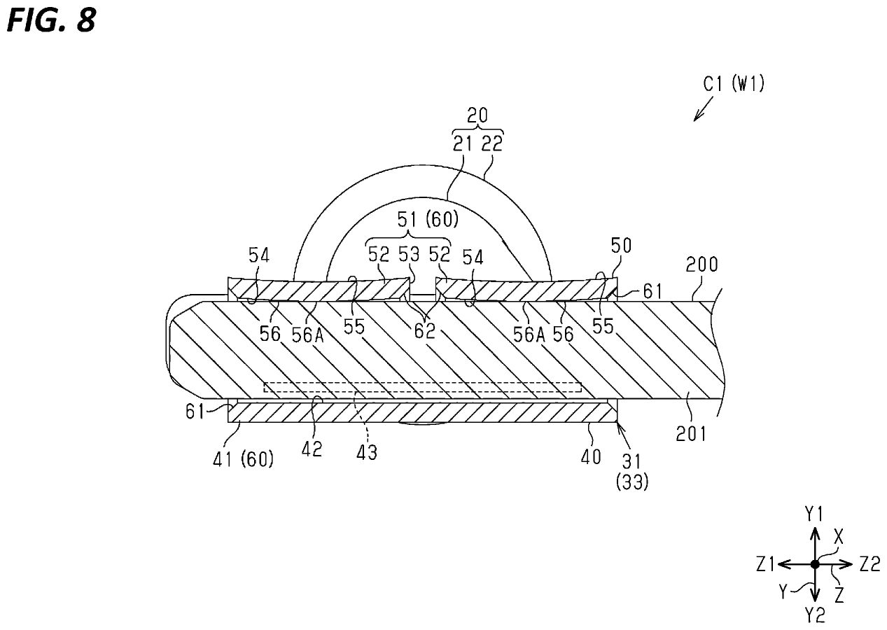

As shown in FIG. 8, each divided tubular portion 52 has an inner surface 54 facing in the first opposite direction Y2 and an outer surface provided on a side opposite to the inner surface 54. As shown in FIG. 7, the outer surface of each divided tubular portion 52 is formed into a curved surface having an arcuate cross-sectional shape obtained by cutting the divided tubular portion 52 by a plane parallel to the X-axis direction. The outer surface of the divided tubular portion 52 is formed to arcuately project radially outwardly of the tubular connecting portion 60 in a cross-section. Similarly, the inner surface 54 of the divided tubular portion 52 is formed to be arcuately recessed radially outwardly of the tubular connecting portion 60 in a cross-section.

The outer surface of each divided tubular portion 52 is provided with a dent portion 55 dented radially inwardly of the tubular connecting portion 60 from the outer surface. As shown in FIG. 6, the dent portion 55 is, for example, formed into a rectangular planar shape when viewed from the Y-axis direction. The dent portion 55 is, for example, formed over the entire length in the Z-axis direction of the divided tubular portion 52.

As shown in FIG. 8, the inner surface 54 of each divided tubular portion 52 is provided with a protrusion 56 projecting radially inwardly of the tubular connecting portion 60 from the inner surface 54. The protrusion 56 is, for example, provided on the inner surface 54 of the divided tubular portion 52 in a part where the dent portion 55 is formed. The protrusion 56 can be, for example, formed by embossing. The protrusion 56 is formed into an embossed shape by pressurizing the outer surface of the divided tubular portion 52 by a die.

The protrusion 56 is, for example, formed such that a cross-sectional shape obtained by cutting the protrusion 56 by a plane parallel to the axial direction of the tubular connecting portion 60 (here, the Z-axis direction) is a shape arcuately projecting radially inwardly of the tubular connecting portion 60. The protrusion 56 is formed to arcuately project radially inwardly of the tubular connecting portion 60 from the inner surface 54 in a cross-section. The protrusion 56 extends, for example, along the circumferential direction of the tubular connecting portion 60. The protrusion 56 extends, for example, along the axial direction of the tubular connecting portion 60. A projecting tip 56A of the protrusion 56 contacts the outer peripheral surface of the columnar connecting portion 201 of the male terminal 200. The projecting tip 56A is, for example, brought into point contact with the outer peripheral surface of the columnar connecting portion 201.

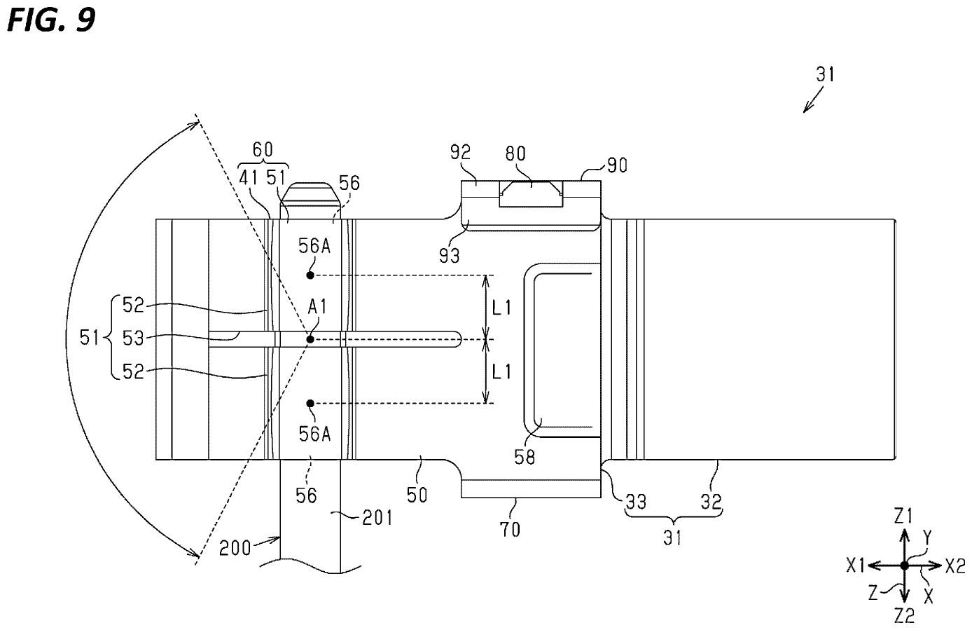

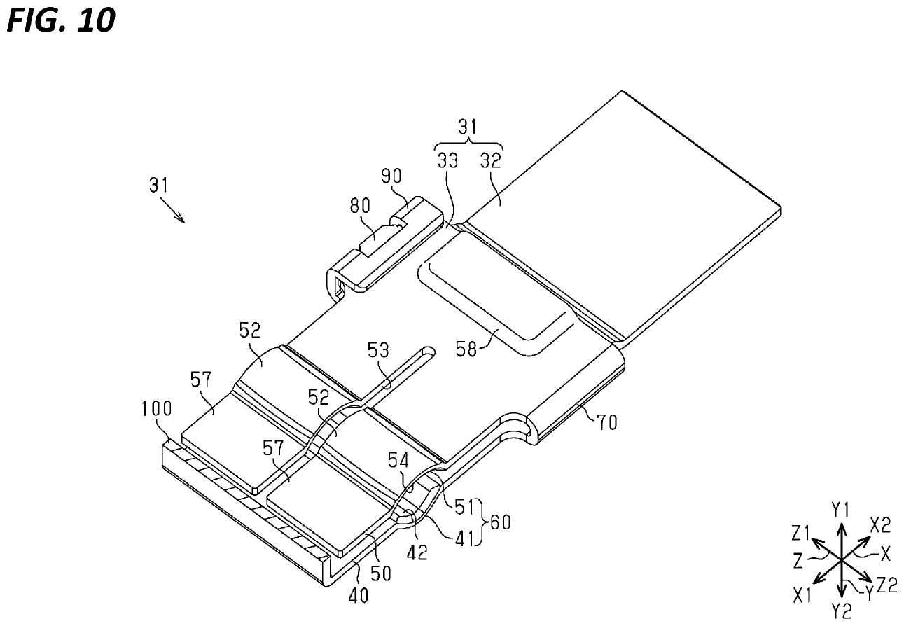

As shown in FIG. 9, each projecting tip 56A is provided at a center in the axial direction of the divided tubular portion 52. Each projecting tip 56A is provided at a position separated from a center A1 of the tubular connecting portion 60 in the axial direction by a first distance L1 in the axial direction of the tubular connecting portion 60. Each projecting tip 56A is provided at a center in the X-axis direction of the divided tubular portion 52.

The slit 53 is formed to penetrate through the tubular portion 51 in the Y-axis direction. That is, the slit 53 penetrates through the peripheral wall 40 in both the second direction Y1 and the second opposite direction Y2. The slit 53 is provided between the two divided tubular portions 52 in the axial direction of the tubular portion 51. The slit 53 is, for example, provided at a center position of the tubular connecting portion 60 in the axial direction of the tubular connecting portion 60.

As shown in FIG. 10, the slit 53 extends over the entire circumferential length of the tubular portion 51 along the circumferential direction of the tubular portion 51. The slit 53 extends, for example, along the first direction X1 from the divided tubular portions 52 to an end surface in the first direction X1 of the peripheral wall 50. The slit 53 extends, for example, in the first opposite direction X2 from the divided tubular portions 52. In other words, the slit 53 extends from the end surface in the first direction X1 of the peripheral wall 50 up to a position further in the first opposite direction X2 than the divided tubular portions 52 along the first opposite direction X2. The slit 53 is open in the first direction X1. That is, the slit 53 is formed to be cut in the first opposite direction X2 from the end surface in the first direction X1 of the peripheral wall 50.

The end part in the first direction X1 of the peripheral wall 50 has a forked structure divided by the slit 53. That is, the end part in the first direction X1 of the peripheral wall 50 includes two divided portions 57 by being forked. Each divided portion 57 includes the divided tubular portion 52. Each divided portion 57 is, for example, formed to be supported in a cantilever manner on the end part in the first opposite direction X2 of the peripheral wall 50. The two divided portions 57 have, for example, the same structure. The two divided portions 57 are plane-symmetrically formed with respect to a virtual plane including a center of the slit 53 in the Z-axis direction and extending in the X-axis direction.

As shown in FIG. 8, each of both end parts in the axial direction of the tubular connecting portion 60 includes, for example, a guiding portion 61. Each guiding portion 61 is formed to increase an opening width (here, an inner diameter) of the tubular connecting portion 60 toward an opening end in the axial direction of the tubular connecting portion 60. Each guiding portion 61 is, for example, formed by inclining the inner surface of the tubular connecting portion 60 radially outwardly of the tubular connecting portion 60 toward the opening end of the tubular connecting portion 60. Each guiding portion 61 is, for example, formed over the entire periphery in the circumferential direction of the inner surface 42 of the tubular portion 41 and formed over the entire periphery in the circumferential direction of the inner surface 54 of the tubular portion 51. Each guiding portion 61 functions to smoothly guide the columnar connecting portion 201 into the tubular connecting portion 60 when the columnar connecting portion 201 of the male terminal 200 is inserted into the tubular connecting portion 60. Since such guiding portions 61 are provided on the both end parts in the axial direction of the tubular connecting portion 60, insertion resistance can be caused to similarly change, regardless of in which of the both end parts in the axial direction of the tubular connecting portion 60 an insertion opening into the tubular connecting portion 60 for the male terminal 200 is set. Thus, the limitation of an insertion direction of the male terminal 200 with respect to the axial direction of the tubular connecting portion 60 can be eliminated.

Out of end parts in the axial direction of the divided tubular portion 52, the end part facing the other divided tubular portion 52 includes, for example, a guiding portion 62. Each guiding portion 62 is formed to increase an opening width of the divided tubular portions 62 toward the other divided tubular portion 52. Each guiding portion 62 is, for example, formed over the entire periphery in the circumferential direction of the inner surface 54 of the divided tubular portion 52.

As shown in FIG. 4, the peripheral wall 50 includes, for example, a convex portion 58. The convex portion 58 is provided at a position overlapping the winding/pressing portion 90 in a plan view viewed from the Z-axis direction. The convex portion 58 is, for example, provided on an end part in the first opposite direction X2 of the peripheral wall 50. The convex portion 58 extends, for example, in the first direction X1 from an end surface in the first opposite direction X2 of the peripheral wall 50. The convex portion 58 does not extend up to the tubular portion 51 in the X-axis direction. The convex portion 58 does not extend up to the slit 53 in the X-axis direction. The convex portion 58 is, for example, provided at an intermediate position in the Z-axis direction of the peripheral wall 50. The convex portion 58 is, for example, formed into a rectangular planar shape when viewed from the Y-axis direction. The convex portion 58 can be, for example, formed by embossing.

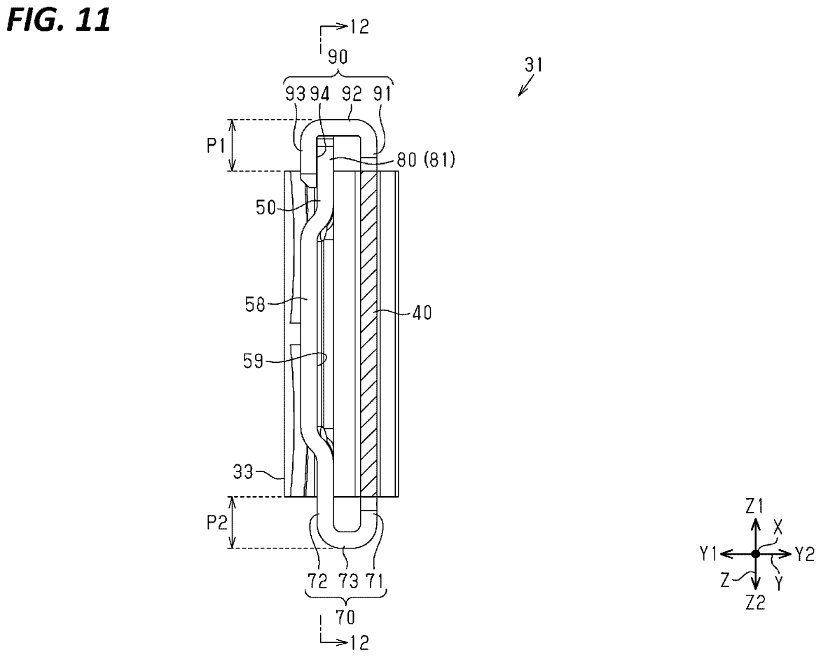

As shown in FIG. 11, the peripheral wall 50 is provided with a concave portion 59 in the inner surface of a part where the convex portion 58 is formed. The concave portion 59 is formed to be recessed in a direction separating from the peripheral wall 40 from the inner surface of the peripheral wall 50.

### Configuration of Coupling Portion 70

As shown in FIG. 4, the coupling portion 70 couples the peripheral walls 40, 50. The coupling portion 70 couples an end part in the third opposite direction Z2 of the peripheral wall 40 and an end part in the third opposite direction Z2 of the peripheral wall 50. The coupling portion 70 is integrally formed to the peripheral wall 40 and integrally formed to the peripheral wall 50. The coupling portion 70 is formed to extend in the second direction Y1 from an end surface in the third opposite direction Z2 of the peripheral wall 40 toward an end surface in the third opposite direction Z2 of the peripheral wall 50. The coupling portion 70 is formed to be folded from the end surface in the third opposite direction Z2 of the peripheral wall 40 toward the end surface in the third opposite direction Z2 of the peripheral wall 50.

The coupling portion 70 is, for example, provided on an end part in the first opposite direction X2 of the peripheral wall 40. The coupling portion 70 extends in the first direction X1 from the end part in the first opposite direction X2 of the peripheral wall 40. The coupling portion 70 projects further in the third opposite direction Z2 than the end surface in the third opposite direction Z2 of the peripheral wall 40 and projects further in the third opposite direction Z2 than the end surface in the third opposite direction Z2 of the peripheral wall 50.

As shown in FIG. 11, the coupling portion 70 includes an extending portion 71 extending in the third opposite direction Z2 from the end surface in the third opposite direction Z2 of the peripheral wall 40 and an extending portion 72 extending in the third opposite direction Z2 from the end surface in the third opposite direction Z2 of the peripheral wall 50. The coupling portion 70 includes a folded portion 73 linking the extending portions 71, 72.

The extending portion 71 is formed to be continuous and integral with the peripheral wall 40. The folded portion 73 is formed to be continuous and integral with the extending portion 71. The folded portion 73 is formed to be folded toward the peripheral wall 50 from an end part of the extending portion 71. The folded portion 73 is, for example, folded in the third direction Z1 into a U shape from the end part of the extending portion 71. The extending portion 72 extends in the third direction Z1 from the folded portion 73 toward the peripheral wall 50. The extending portion 72 is formed to be continuous and integral with the folded portion 73 and formed to be continuous and integral with the peripheral wall 50. The coupling portion 70 is folded into a U shape convex in a direction separating from the peripheral walls 40, 50 (here, in the third opposite direction Z2) by the extending portion 71, the folded portion 73 and the extending portion 72. The coupling portion 70 is so folded that the peripheral wall 50 is arranged to face the peripheral wall 40. In other words, in the terminal connecting portion 33, the peripheral wall 50 is folded into two toward the peripheral wall 40 by the coupling portion 70.

### Configuration of Projecting Portion 80

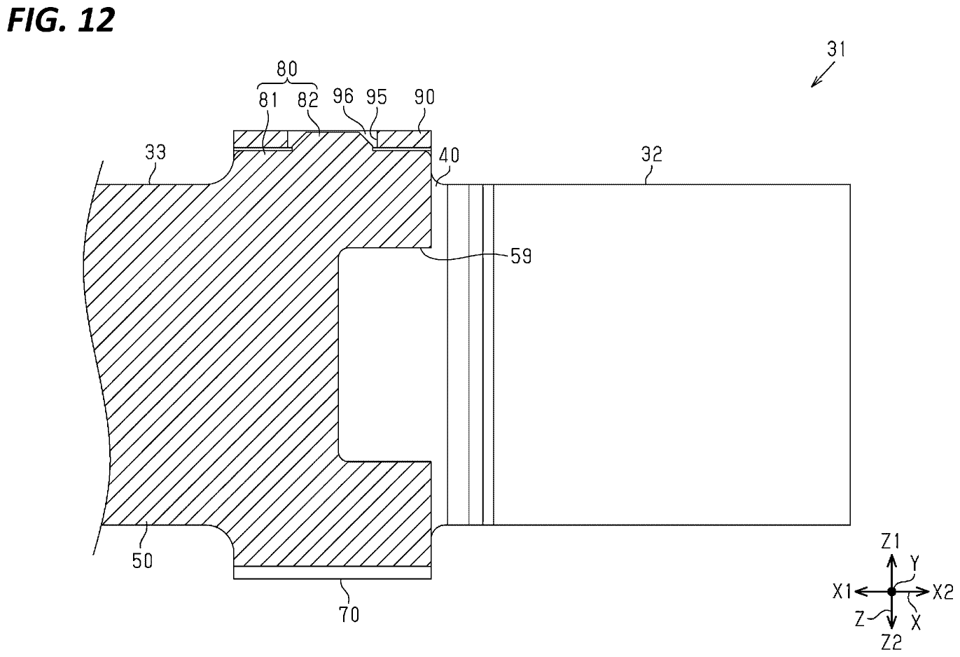

As shown in FIG. 12, the projecting portion 80 is provided on an end surface in the third direction Z1 of the peripheral wall 50. The projecting portion 80 includes, for example, a projecting base portion 81 extending in the third direction Z1 from the end surface in the third direction Z1 of the peripheral wall 50 and a projection 82 extending in the third direction Z1 from a part of the projecting tip surface of the projecting base portion 81. The projecting base portion 81 is formed to be continuous and integral with the peripheral wall 50. The projecting base portion 81 extends along the first direction X1 from an end surface in the first opposite direction X2 of the peripheral wall 50. The projection 82 is formed to be continuous and integral with the projecting base portion 81. The projection 82 projects further in the third direction Z1 than the projecting tip surface, here, the end surface in the third direction Z1, of the projecting base portion 81. The projection 82 is, for example, provided only at an intermediate position in the X-axis direction of the projecting base portion 81. The projection 82 is, for example, formed to reduce a width along the X-axis direction toward the projecting tip surface of the projection 82 from the projecting base portion 81 in a plan view viewed from the Y-axis direction.

### Configuration of Winding/Pressing Portion 90

As shown in FIG. 4, the winding/pressing portion 90 is formed to limit a separation distance between the inner surface 42 of the tubular portion 41 and the inner surface 54 of the tubular portion 51. The winding/pressing portion 90 limits an increase in separation distance between the inner surfaces 42, 54. The winding/pressing portion 90 limits the opening of the coupling portion 70. The winding/pressing portion 90 is integrally formed to the peripheral wall 40. The winding/pressing portion 90 is, for example, provided on the end part in the third direction Z1 of the peripheral wall 40. The winding/pressing portion 90 is, for example, formed to be folded from the peripheral wall 40 while embracing an end edge of the peripheral wall 50 inside. The winding/pressing portion 90 is, for example, formed to be folded from the end surface in the third direction Z1 of the peripheral wall 40 while arranging the end surface in the third direction Z1 of the peripheral wall 50 inside. The winding/pressing portion 90 is in contact with the outer surface of the peripheral wall 50.

The winding/pressing portion 90 is, for example, provided on the end part in the first opposite direction X2 of the peripheral wall 40. The winding/pressing portion 90 extends in the first direction X1 from the end part in the first opposite direction X2 of the peripheral wall 40. The winding/pressing portion 90 is, for example, provided at a position overlapping the coupling portion 70 in a plan view viewed from the Z-axis direction. For example, the winding/pressing portion 90 is provided on a side opposite to the coupling portion 70 across the peripheral wall 40 in the Z-axis direction.

As shown in FIG. 11, the winding/pressing portion 90 includes an extending portion 91 extending in the third direction Z1 from the end surface in the third direction Z1 of the peripheral wall 40, a folded portion 92 provided on an end part of the extending portion 91 and a pressing portion 93 extending from an end part of the folded portion 92 toward the peripheral wall 50.

The extending portion 91 is formed to be continuous and integral with the peripheral wall 40. The folded portion 92 is formed to be continuous and integral with the extending portion 91. The folded portion 92 is formed to be folded toward the peripheral wall 50 from an end part in the third direction Z1 of the extending portion 91. The folded portion 92 is, for example, folded in the third opposite direction Z2 into a U shape from the end part of the extending portion 91. The pressing portion 93 is formed to be continuous and integral with the folded portion 92. The pressing portion 93 extends in the third opposite direction Z2 from the folded portion 92 toward the projecting portion 80 and the peripheral wall 50. The winding/pressing portion 90 is folded into a U shape convex in a direction separating from the peripheral walls 40, 50 (here, the third direction Z1) by the extending portion 91, the folded portion 92 and the pressing portion 93.

The pressing portion 93 is provided to press the outer surface of the peripheral wall 50 from outside. The pressing portion 93 is, for example, provided to press the outer surface of the projecting base portion 81 from outside. The pressing portion 93 has a facing surface 94 facing the outer surface of the peripheral wall 50. The facing surface 94 extends, for example, in parallel to the outer surface of the peripheral wall 50. The facing surface 94 is, for example, in surface contact with the outer surface of the peripheral wall 50.

Here, a first projection amount P1 of the winding/pressing portion 90 from the end surface in the third direction Z1 of the peripheral wall 40 is, for example, equal to a second projection amount P2 of the coupling portion 70 from the end surface in the third opposite direction Z2 of the peripheral wall 40. The first projection amount P1 is a longest distance along the Z-axis direction from the end surface in the third direction Z1 of the peripheral wall 40 to the projecting tip of the winding/pressing portion 90. The second projection amount P2 is a longest distance along the Z-axis direction from the end surface in the third opposite direction Z2 of the peripheral wall 40 to the projecting tip of the coupling portion 70. A length of the folded portion 92 along the Y-axis direction is, for example, larger than that of the folded portion 73 along the Y-axis direction by a thickness of the peripheral wall 50.

A projection amount of the winding/pressing portion 90 along the Y-axis direction from the outer surface of the peripheral wall 50 is, for example, equal to that of the convex portion 58 along the Y-axis direction from the outer surface of the peripheral wall 50. In other words, the convex portion 58 is so formed that the projection amount from the outer surface of the peripheral wall 50 is equal to that of the winding/pressing portion 90.

As shown in FIG. 4, the winding/pressing portion 90 includes a through hole 95, into which the projection 82 is fit. The through hole 95 penetrates through the winding/pressing portion 90 in a thickness direction. The through hole 95 extends, for example, from an intermediate position of the folded portion 92 to an intermediate position of the pressing portion 93. The through hole 95 is formed in a size fittable to the projection 82.

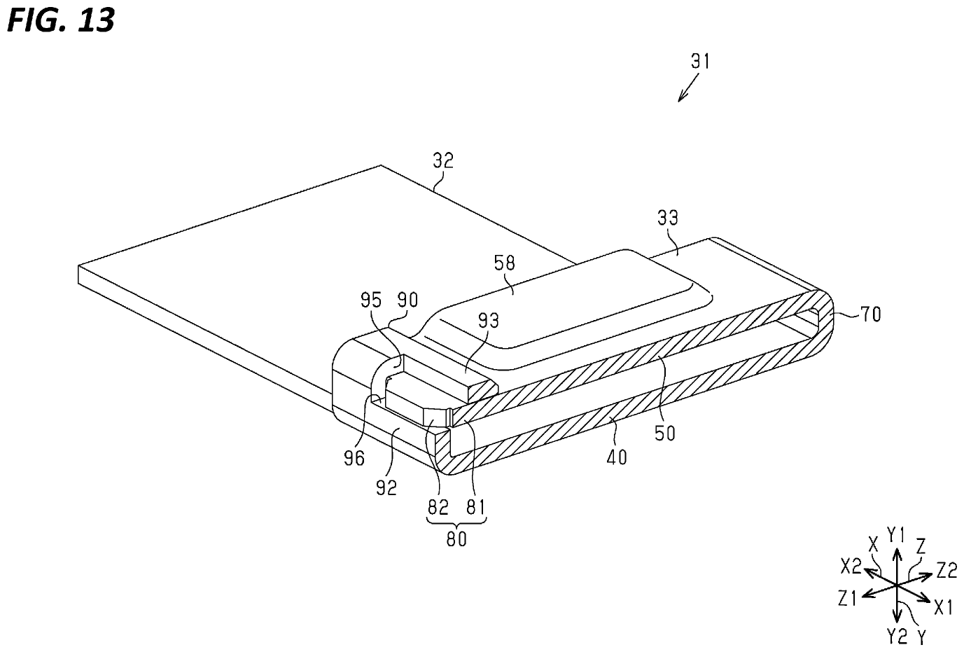

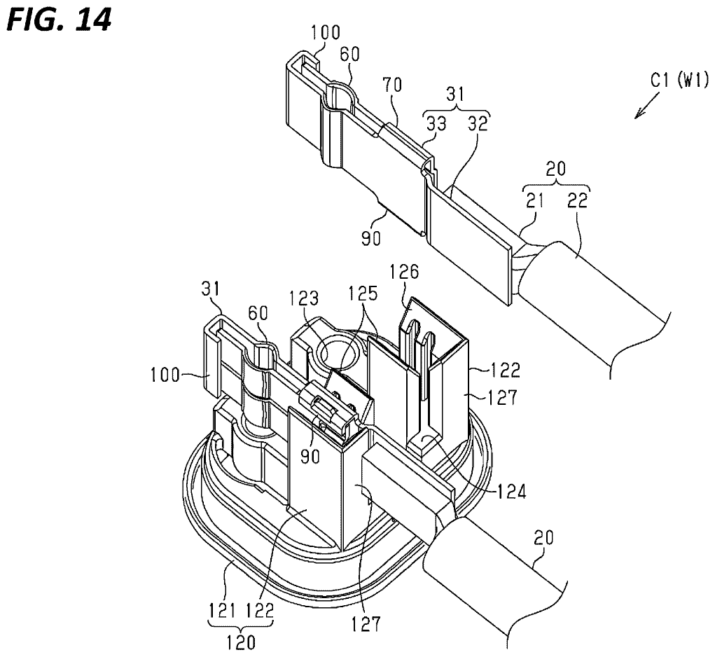

As shown in FIG. 13, the winding/pressing portion 90 has an engagement surface 96 constituting the through hole 95 and to be engaged with the projection 82. The engagement surface 96 is, for example, facing in the second direction Y1. The engagement surface 96 is facing the inner surface of the projection 82 in the Y-axis direction. The engagement surface 96 extends, for example, in parallel to the inner surface of the projection 82. The engagement surface 96 is, for example, in surface contact with the inner surface of the projection 82. The outer surface of the projection 82 is, for example, exposed from the winding/pressing portion 90 through the through hole 95.

In the terminal connecting portion 33 of this embodiment, the outer surface of the peripheral wall 50 is pressed from outside by the pressing portion 93 of the winding/pressing portion 90, and the engagement surface 96 of the winding/pressing portion 90 is pressed from outside by the projection 82 of the projecting portion 80. In this way, an increase in separation distance between the peripheral walls 40, 50 can be stably limited.

### Configuration of Protecting Portion 100

As shown in FIG. 4, the protecting portion 100 is, for example, provided to protect an end part in the first direction X1 of the terminal connecting portion 33. The protecting portion 100 is provided on the end part in the first direction X1 of the peripheral wall 40. The protecting portion 100 is, for example, integrally formed to the peripheral wall 40. The protecting portion 100 is formed to be folded from the end part in the first direction X1 of the peripheral wall 40 while arranging the end part in the first direction X1 of the peripheral wall 50 inside.

The protecting portion 100 includes an extending portion 101 extending in the second direction Y1 from the end part in the first direction X1 of the peripheral wall 40 and a protection wall 102 extending toward the peripheral wall 50 from an end part in the second direction Y1 of the extending portion 101. The extending portion 101 is formed to be continuous and integral with the peripheral wall 40. The protection wall 102 is formed to be continuous and integral with the extending portion 101. The protecting portion 100 is folded into a U shape convex in a direction separating from the peripheral wall 50 (here, in the first direction X1) by the extending portion 101 and the protection wall 102. The protection wall 102 is provided to face the end part in the first direction X1 of the peripheral wall 50 in the Y-axis direction. The protection wall 102 is provided away from the outer surface of the peripheral wall 50. That is, a gap is provided between the protection wall 102 and the outer surface of the peripheral wall 50. The protection wall 102 is, for example, provided away from the outer surface of the peripheral wall 50 with the columnar connecting portion 201 inserted in the tubular connecting portion 60. Note that a length of the extending portion 101 along the Y-axis direction is larger than that of the folded portion 92 along the Y-axis direction.

### Configuration of Housing Body 110

As shown in FIG. 3, the housing body 110 holds the female terminals 31 such that the wires 20 are drawn out in the first opposite direction X2. The housing body 110 accommodates the two female terminals 31 inside. The housing body 110 is, for example, formed into a box shape as a whole. The housing body 110 is, for example, made of synthetic resin.

The housing body 110 includes an opening 111 open in the first opposite direction X2. The wire 20 connected to the female terminal 31 is pulled out to the outside of the housing body 110 through the opening 111. The housing body 110 includes, for example, a peripheral wall 112 provided in the third opposite direction Z2 and a tube portion 113 provided on the outer surface of the peripheral wall 112. The tube portion 113 is a fitting tube portion, to which a mating housing of the unillustrated mating connector is fit. The tube portion 113 is provided on an end part in the first direction X1 of the peripheral wall 112. The tube portion 113 projects radially outwardly of the housing body 110 (here, in the third opposite direction Z2) from the outer surface of the peripheral wall 112. The tube portion 113 is, for example, formed into a rectangular tube shape.

The tube portion 113 includes an insertion hole 114. The insertion hole 114 is formed to allow communication between the inside and outside of the housing body 110. The insertion hole 114 is open in the third direction Z1 and also in the third opposite direction Z2. For example, the insertion hole 114 penetrates through the tube portion 113 in the Z-axis direction and penetrates through the peripheral wall 112 in the Z-axis direction. The insertion hole 114 is formed to expose the female terminals 31 accommodated in the housing body 110. Here, each female terminal 31 accommodated inside the housing body 110 is so provided that an opening end of the tubular connecting portion 60 is exposed through the insertion hole 114.

### Configuration of Retainer 120

The retainer 120 is mounted into the tube portion 113 of the housing body 110. The retainer 120 includes a body portion 121 and one or more (two in this embodiment) restricting portions 122 for restricting movements of the female terminals 31 in the first opposite direction X2. The retainer 120 is, for example, a single component in which the body portion 121 and the restricting portions 122 are continuously and integrally formed. The retainer 120 is, for example, made of synthetic resin.

The body portion 121 is, for example, formed into a frame shape as a whole. The outer peripheral edge of the body portion 121 is, for example, formed to have a rectangular planar shape when viewed from the Z-axis direction. The body portion 121 is, for example, formed to cover an end surface in the third opposite direction Z2 of the tube portion 113.

The body portion 121 includes one or more (two in this embodiment) insertion holes 123. Each insertion hole 123 penetrates through the body portion 121 in the Z-axis direction. Each insertion hole 123 is formed to communicate with the insertion hole 114 of the tube portion 113. The two insertion holes 123 are, for example, formed to expose the respective opening ends of the tubular connecting portions 60 of the two female terminals 31 accommodated in the housing body 110.

As shown in FIG. 14, the two restricting portions 122 are respectively provided to correspond to the two female terminals 31. The two restricting portions 122 are, for example, provided side by side along the Y-axis direction. Each restricting portion 122 is, for example, in the form of a tube, into which a part of the female terminal 31 is accommodated. Each restricting portion 122 has a U-shaped transverse cross-sectional shape as a whole. An axial direction of each restricting portion 122 extends along the X-axis direction. Each restricting portion 122 is open in the first direction X1 and also in the first opposite direction X2. Each restricting portion 122 is open in the third direction Z1.

Each female terminal 31 is, for example, inserted into an internal space of each restricting portion 122 along the third opposite direction Z2. An end part in the first opposite direction X2 of the terminal connecting portion 33 in each female terminal 31 is, for example, accommodated into the internal space of each restricting portion 122. The two female terminals 31 are, for example, respectively accommodated in the two restricting portions 122 in orientations different from each other. In particular, the female terminal 31 is accommodated in the restricting portion 122 provided on the second direction Y1 side, out of the two restricting portions 122, in such a posture that the winding/pressing portion 90 is facing in the third direction Z1. The female terminal 31 is accommodated in the restricting portion 122 provided on the second opposite direction Y2 side, out of the two restricting portions 122, in such a posture that the winding/pressing portion 90 is facing in the third opposite direction Z2. Specifically, the female terminal 31 provided on the second opposite direction Y2 side is accommodated in the restricting portion 122 in a posture rotated from the female terminal 31 on the second direction Y1 side by 180°. As shown in FIG. 3, each restricting portion 122 is inserted into the housing body 110 along the third direction Z1 when the retainer 120 is mounted into the tube portion 113 of the housing body 110. At this time, each restricting portion 122 is inserted into the housing body 110 to accommodate the female terminal 31 inside.

As shown in FIGS. 14, 15 and 16, each restricting portion 122 includes a bottom wall 124, a side wall 125 projecting from a first side edge of the bottom wall 124 and a side wall 126 projecting from a second side edge of the bottom wall 124. The first side edge of the bottom wall 124 is facing the bottom wall 124 of the other restricting portion 122. The second side edge of the bottom wall 124 is provided on a side opposite to the first side edge in the Y-axis direction.

As shown in FIG. 16, each side wall 125, 126 is formed to be continuous and integral with the bottom wall 124. Each side wall 125, 126 projects in the third direction Z1 from the bottom wall 124. Each side wall 125, 126 is, for example, in the form of a plate. The two side walls 125, 126 are, for example, facing each other in a width direction of the bottom wall 124 (here, the Y-axis direction).

An interval between the inner surface of the side wall 125 and that of the side wall 126 is, for example, set to be able to accommodate the winding/pressing portion 90. A shortest distance between the inner surface of the side wall 125 and that of the side wall 126 is set to be slightly larger than a longest distance of the winding/pressing portion 90 along the Y-axis direction. Here, the convex portion 58 of the female terminal 31 is so formed that the projection amount along the Y-axis direction from the outer surface of the peripheral wall 50 is equal to the projection amount along the Y-axis direction of the winding/pressing portion 90. Thus, the convex portion 58 can be suitably accommodated between the inner surface of the side wall 125 and that of the side wall 126. By providing such a convex portion 58, gaps between the female terminal 31 and the inner surfaces of the side walls 125, 126 can be suppressed from becoming larger in a part where the winding/pressing portion 90 is not provided. In this way, the inclination of the female terminal 31 inside each restricting portion 122 can be suitably suppressed.

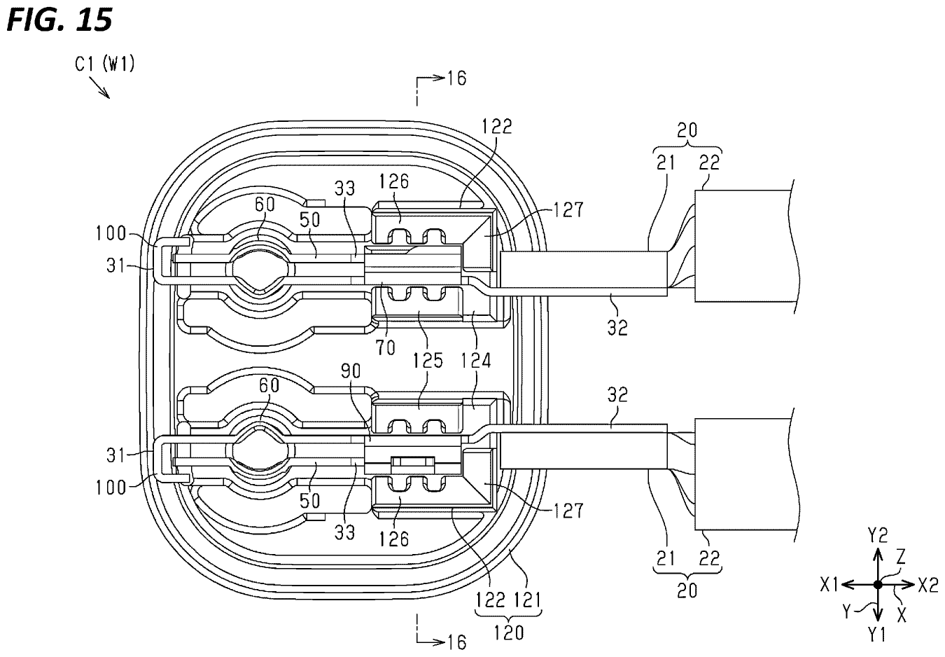

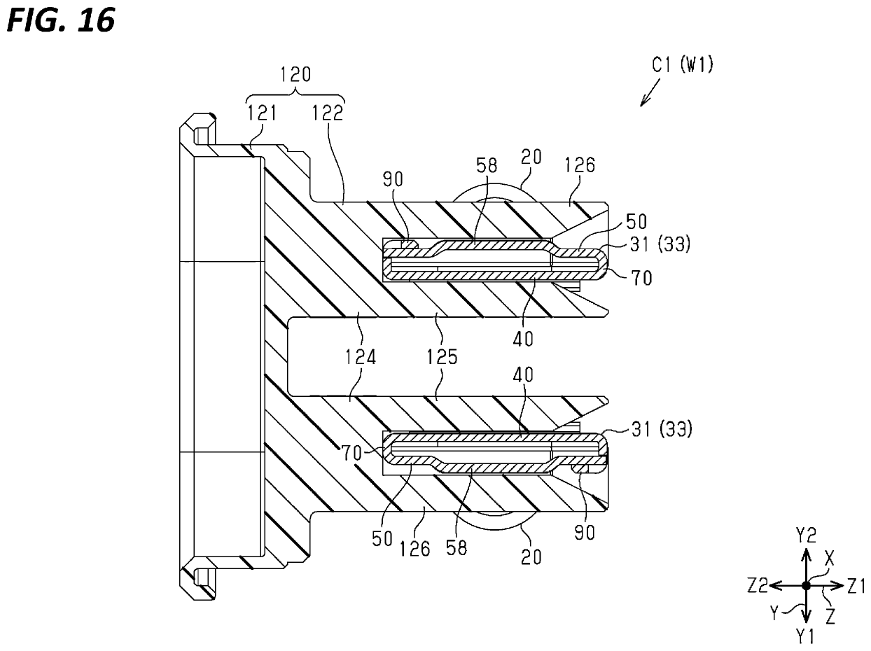

As shown in FIG. 15, each restricting portion 122 includes an engagement wall 127 to be engaged with the female terminal 31. The engagement wall 127 is, for example, provided to close a part of an opening in the first opposite direction X2 of the restricting portion 122. The engagement wall 127 is, for example, formed to be continuous and integral with the bottom wall 124. The engagement wall 127 is, for example, formed to be continuous and integral with the side wall 126. The engagement wall 127 extends, for example, toward the side wall 125 along the Y-axis direction from an end part in the first opposite direction X2 of the side wall 126. The engagement wall 127 extends up to the side wall 125 in the Y-axis direction.

The engagement wall 127 is provided to be engageable with the end surface in the first opposite direction X2 of the peripheral wall 50 of the female terminal 31 in the first direction X1 when the retainer 120 is mounted into the housing body 110 (see FIG. 2). The engagement wall 127 restricts a movement of the female terminal 31 in the first opposite direction X2. The restricting portion 122 including such an engagement wall 127 assures the position in the X-axis direction of the female terminal 31 inside the housing body 110 (see FIG. 2).

Next, functions of the female terminal 31 are described.

As shown in FIG. 9, the columnar connecting portion 201 of the male terminal 200 is press-fit into the tubular connecting portion 60. Here, if a swinging movement of the male terminal 200 is transmitted, for example, from an unillustrated mating wire or the like, the columnar connecting portion 201 may be displaced in directions of arrows in FIG. 9 inside the tubular connecting portion 60 due to that swinging movement. Specifically, the columnar connecting portion 201 may rotate in the direction of the arrow in FIG. 9 with the center A1 of the tubular connecting portion 60 in the axial direction as a center of rotation due to the swinging movement. At this time, if the projecting tip 56A of the protrusion 56 provided on the tubular portion 51 is, for example, provided at the center A1 of the tubular connecting portion 60, a contact part of the projecting tip 56A of the protrusion 56 and the columnar connecting portion 201 serves as a center of rotation in the displacement of the columnar connecting portion 201. In this case, a contact pressure with the columnar connecting portion 201 by the protrusion 56 does not act as a force for suppressing a displacement of the columnar connecting portion 201.

In contrast, in the female terminal 31 of this embodiment, the tubular portion 51 is divided into two to form the two divided tubular portions 52, and the protrusion 56 is formed on the inner surface 54 of each of the two divided tubular portions 52. The projecting tip 56A of each protrusion 56 is provided at a position separated from the center A1 of the tubular connecting portion 60 by the first distance L1. In this way, the projecting tip 56A of each protrusion 56 can be brought into contact with the outer peripheral surface of the columnar connecting portion 201 at the position separated from the center A1 serving as the center of rotation in the displacement of the columnar connecting portion 201. Thus, the contact pressure with the columnar connecting portion 201 by each protrusion 56 can be exerted as a force for suppressing the displacement of the columnar connecting portion 201. In particular, each protrusion 56 can suppress the displacement of the columnar connecting portion 201 with a force of F1×μ×L1 F1 denotes the contact pressure with the columnar connecting portion 201 by each protrusion 56 and u denotes a friction coefficient. Therefore, the two protrusions 56 can suppress the displacement of the columnar connecting portion 201 with a force of 2×F1×μ×L1.

Note that, even if a contact part of the columnar connecting portion 201 and the projecting tip 56A on the third direction Z1 side, out of the two projecting tips 56A, serves as the center of rotation in the displacement of the columnar connecting portion 201, the displacement of the columnar connecting portion 201 can be suppressed with a force similar to the one when the center A1 serves as the center of rotation. In particular, the projecting tip 56A on the third opposite direction Z2 side, out of the two projecting tips 56A, is provided at a position separated from the other projecting tip 56A serving as the center of rotation by a distance of 2×L1. Thus, the protrusion 56 on the third opposite direction Z2 side can suppress the displacement of the columnar connecting portion 201 with a force of 2×F1×μ×L1 .

Next, functions and effects of this embodiment are described.
(1) The female terminal 31 is provided with the peripheral wall 50 having the tubular portion 51, the peripheral wall 40 having the tubular portion 41 provided to face the tubular portion 51, and the tubular connecting portion 60 composed of the tubular portions 41, 51. The tubular connecting portion 60 is a first connecting portion, into which the columnar connecting portion 201 of the male terminal 200 is inserted and which is electrically connected to the columnar connecting portion 201. The tubular portion 51 includes the plurality of divided tubular portions 52 divided in the axial direction of the tubular connecting portion 60. Each of the plurality of divided tubular portions 52 has the inner surface 54 facing the tubular portion 41 and the protrusion 56 arcuately projecting radially inwardly of the tubular connecting portion 60 from the inner surface 54 in a cross-section.

According to this configuration, when the columnar connecting portion 201 of the male terminal 200 is press-fit into the tubular connecting portion 60, the protrusion 56 provided on the inner surface 54 of each of the plurality of divided tubular portions 52 is pressed into contact with the outer peripheral surface of the columnar connecting portion 201. Thus, in the tubular connecting portion 60, the plurality of protrusions 56 are pressed into contact with the outer peripheral surface of the columnar connecting portion 201 at a plurality of positions separated in the axial direction. In this way, even if a swinging movement is, for example, transmitted to the male terminal 200, a displacement of the male terminal 200 due to that swinging movement can be suitably hindered by the contact of the plurality of protrusions 56 with the columnar connecting portion 201. That is, as compared to the case where only one protrusion 56 is provided on the inner surface of the tubular portion 51, the displacement of the columnar connecting portion 201 inside the tubular connecting portion 60 can be suppressed by the contact pressures by the plurality of protrusions 56.
(2) When the columnar connecting portion 201 is press-fit into the tubular connecting portion 60, the two protrusions 56 are brought into contact with the outer peripheral surface of the columnar connecting portion 201. Thus, a combined contact resistance as a combination of contact resistances at the two protrusions 56 can be reduced as compared to the case where only one protrusion 56 is provided on the inner surface of the tubular portion 51. In this way, thermal performance can be improved.
(3) The slit 53 dividing the two divided tubular portions 52 is provided at the center A1 of the tubular connecting portion 60 in the axial direction. At this time, when the columnar connecting portion 201 of the male terminal 200 inserted into the tubular connecting portion 60 is displaced, the columnar connecting portion 201 rotates with the center A1 of the tubular connecting portion 60 in the axial direction as a center of rotation. If the contact part of the protrusion 56 and the columnar connecting portion 201 is provided at such a center of rotation, a contact pressure with the columnar connecting portion 201 by the protrusion 56 cannot be exerted as a force for suppressing a displacement of the columnar connecting portion 201. In contrast, in the female terminal 31 of this embodiment, the protrusions 56 are provided at positions different from the slit 53 provided at the center A1 of the tubular connecting portion 60 in the axial direction. Thus, the protrusions 56 and the columnar connecting portion 201 can be brought into contact at the positions different from the center of rotation in the displacement of the columnar connecting portion 201. In this way, the contact pressures with the columnar connecting portion 201 by the protrusions 56 can be suitably exerted as a force for suppressing the displacement of the columnar connecting portion 201. As a result, the displacement of the columnar connecting portion 201 inside the tubular connecting portion 60 can be suitably suppressed by the contact pressures by the plurality of protrusions 56.
(4) The slit 53 extends along the first opposite direction X2 from the end surface in the first direction X1 of the peripheral wall 50. The slit 53 is open in the first direction X1. According to this configuration, the end part in the first direction X1 of the peripheral wall 50 including the tubular portion 51 is formed into a structure forked by the slit 53. Thus, the two divided tubular portions 52 are formed into structures independent of each other. In this way, the contact pressures with the columnar connecting portion 201 of the male terminal 200 can be ensured independently by the respective two divided tubular portions 52.
(5) The two divided tubular portions 52 are plate-symmetrically formed. Thus, the contact pressures equal to each other can be ensured in the two divided tubular portions 52 provided on both sides of the slit 53. In this way, the contact pressures can be ensured in a well-balanced manner on the both sides of the slit 53.
(6) The projecting tip 56A of each protrusion 56 is provided at the position separated from the center A1 of the tubular connecting portion 60 in the axial direction by the first distance L. Thus, the projecting tip 56A of the protrusion 56 and the columnar connecting portion 201 can be brought into contact at the position separated from the center of rotation in the displacement of the columnar connecting portion 201 by the first distance L1. In this way, the contact pressure by the protrusion 56 can be suitably exerted as a force for suppressing the displacement of the columnar connecting portion 201. As a result, the displacement of the columnar connecting portion 201 inside the tubular connecting portion 60 can be suitably suppressed by the contact pressures by the plurality of protrusions 56.
(7) The tubular connecting portion 60 includes the plurality of linear contact portions 43 projecting radially inwardly of the tubular connecting portion 60 from the inner surface 42 and provided at the positions separated from each other in the circumferential direction of the tubular connecting portion 60. The linear contact portions 43 extend along the axial direction of the tubular connecting portion 60. According to this configuration, when the columnar connecting portion 201 of the male terminal 200 is press-fit into the tubular connecting portion 60, the linear contact portions 43 provided on the inner surface 42 constituting the tubular connecting portion 60 are pressed into line contact with the outer peripheral surface of the columnar connecting portion 201 at a plurality of positions separated in the circumferential direction. In this way, for example, even if a swinging movement is transmitted to the male terminal 200, a displacement of the male terminal 200 due to that swinging movement can be hindered by the contact of the plurality of linear contact portions 43 with the columnar connecting portion 201.
(8) When the columnar connecting portion 201 of the male terminal 200 is press-fit into the tubular connecting portion 60, an increase in separation distance between the inner surface 42 constituting the tubular connecting portion 60 and the inner surface 54 constituting the tubular connecting portion 60 is limited by the winding/pressing portion 90. By this limitation by the winding/pressing portion 90, the protrusions 56 and the linear contact portions 43 can be suitably brought into contact with the outer peripheral surface of the columnar connecting portion 201. As a result, the tubular connecting portion 60 and the columnar connecting portion 201 can be suitably held in a press-contact state. Further, the winding/pressing portion 90 is integrally formed to the peripheral wall 40. Thus, the tubular connecting portion 60 and the columnar connecting portion 201 can be held in the press-contact state by a simple structure as compared to the case where a separate component such as a coil spring is used. That is, the structure of the female terminal 31 can be simplified as compared to the case where a separate component such as a coil spring is used.
(9) The peripheral walls 40, 50 are coupled by the coupling portion 70 integrally formed to the both peripheral walls 40, 50. In this way, the peripheral walls 40, 50 can be integrally formed through the coupling portion 70. Thus, the female terminal 31 can be configured, such as by bending one metal plate. As a result, the structure of the female terminal 31 can be simplified.
(10) The protection wall 102 of the protecting portion 100 integrally formed to the peripheral wall 40 is provided to face the end part in the first direction X1 of the peripheral wall 50 while being separated from this end part. Thus, the deformation of the peripheral wall 50 can be suitably hindered by the protection wall 102, for example, even if an excessive external force is accidentally applied to the end part in the first direction X1 of the peripheral wall 50 and the peripheral wall 50 is deformed away from the peripheral wall 40 due to that external force.
(11) The winding/pressing portion 90 is provided on the end part in the first opposite direction X2 of the peripheral wall 40. The tubular connecting portion 60 is provided at the intermediate position between the winding/pressing portion 90 and the protecting portion 100 in the first direction X1. According to this configuration, the winding/pressing portion 90 is provided at a position different from the tubular connecting portion 60 in the first direction X1. An increase in separation distance between the peripheral walls 40, 50 can be limited by such a winding/pressing portion 90. Consequently, an increase in separation distance between the inner surface 42 constituting the tubular connecting portion 60 and the inner surface 54 constituting the tubular connecting portion 60 can be limited by the winding/pressing portion 90.
(12) The wire connecting portion 32 to be electrically connected to the wire 20 is integrally formed to the first peripheral wall 40. Thus, the number of components of the female terminal 31 can be reduced and the structure of the female terminal 31 can be simplified.

### Other Embodiments

The above embodiment can be modified and carried out as follows. The above embodiment and the following modifications can be combined with each other and carried out without technically contradicting.
The structure of the female terminal 31 in the above embodiment can be changed as appropriate.
The convex portion 58 of the female terminal 31 may be omitted. In this case, the concave portion 59 of the female terminal 31 is also omitted.
Although the protecting portion 100 is integrally formed to the peripheral wall 40 in the above embodiment, there is no limitation to this. For example, the protecting portion 100 may be integrally formed to the peripheral wall 50. The protecting portion 100 in this case is, for example, formed to be folded from the end part in the first direction X1 of the peripheral wall 50 while arranging the end part in the first direction X1 of the peripheral wall 40 inside.
The protecting portion 100 of the female terminal 31 may be omitted.
The guiding portions 62 in the divided tubular portions 52 of the female terminal 31 may be omitted.
The guiding portions 61 in the tubular connecting portion 60 of the female terminal 31 may be omitted.
Although each protrusion 56 is formed over the entire length in the axial direction of the divided tubular portion 52 in the female terminal 31 of the above embodiment, there is no limitation to this. For example, each protrusion 56 may be provided only at an intermediate position in the axial direction of the divided tubular portion 52.
Three or more linear contact portions 43 may be provided on the inner surface 42 of the tubular portion 41 of the female terminal 31.
The plurality of linear contact portions 43 and the protrusion 56 having an arcuate cross-section may be provided on the inner surface 42 of the female terminal 31.
Although the plurality of linear contact portions 43 are provided on the inner surface 42 of the tubular portion 41 and the tubular portion 51 includes the plurality of divided tubular portions 52 and the protrusions 56 provided on the inner surfaces 54 of the divided tubular portions 52 in the female terminal 31 of the above embodiment, there is no limitation to this. For example, the tubular portion 41 may include the plurality of divided tubular portions 52 and the protrusions 56 provided on the inner surfaces 54 of the divided tubular portions 52.
The structure of the slit 53 of the above embodiment can be changed as appropriate. The structure of the slit 53 is not particularly limited if the slit 53 can divide the adjacent divided tubular portions 52. For example, the slit 53 may not extend up to the end surface in the first direction X1 of the peripheral wall 50 from the divided tubular portions 52.
Although the two divided tubular portions 52 are plane-symmetrically formed in the tubular portion 51 of the above embodiment, there is no limitation to this. For example, the protrusions 56 in the two divided tubular portions 52 may be set to have mutually different heights. For example, separation distances between the projecting tips 56A of the two protrusions 56 and the center A1 may be set to be different from each other.
The number of the divided tubular portions 52 of the tubular portion 51 of the above embodiment is not particularly limited. For example, the tubular portion 51 may include three or more divided tubular portions 52. The tubular portion 51 in this case includes two or more slits 53. Note that the number of the divided tubular portions 52 of the tubular portion 51 is preferably an even number. By setting the number of the divided tubular portions 52 to an even number, the projecting tips 56A of all the protrusions 56 can be suitably provided at positions different from the center A1 of the tubular connecting portion 60 in the axial direction.
The position of the winding/pressing portion 90 in the female terminal 31 may be changed as appropriate. For example, the winding/pressing portion 90 may be provided at a position different from the coupling portion 70 in the X-axis direction.
Although the contact pressure with the columnar connecting portion 201 is ensured by limiting the separation distance between the inner surfaces 42 and 54 by the winding/pressing portion 90 in the above embodiment, there is no limitation to this. For example, the contact pressure with the columnar connecting portion 201 may be ensured, for example, using a biasing member such as a coil spring separate from the peripheral walls 40, 50.
Although the wire connecting portion 32 is integrally formed to the peripheral wall 40 in the above embodiment, there is no limitation to this. For example, the wire connecting portion 32 may be integrally formed to the peripheral wall 50.
In the female terminal 31 of the above embodiment, only the terminal connecting portion 33, out of the wire connecting portion 32 and the terminal connecting portion 33, is structured by folding the peripheral wall 50 into two on the peripheral wall 40. Without limitation to this, for example, both the wire connecting portion 32 and the terminal connecting portion 33 may be structured by folding two plate materials.
The structure of the housing body 110 in the above embodiment can be changed as appropriate if the housing body 110 is structured to be able to accommodate the female terminals 31.
The structure of the retainer 120 in the above embodiment can be changed as appropriate. For example, the restricting portions 122 may be omitted.
Although the columnar connecting portion 201 of the male terminal 200 is embodied to have a cylindrical shape in the above embodiment, there is no limitation to this. For example, the columnar connecting portion 201 may be formed into a columnar shape other than the cylindrical shape. For example, a transverse cross-sectional shape of the columnar connecting portion 201 may be formed into an elliptical shape or a polygonal shape.
As shown in FIGS. 4 to 7, the columnar connecting portion 201 of the male terminal 200 according to the non-limiting embodiment is an example of an electrically conductive straight rod having a longitudinal axis (arrow Z in figures), an axial length and a radial thickness. This electrically conductive straight rod may have a smooth side surface as shown in FIG. 7 and may be, for example, a cylindrical rod having a substantially circular cross-section.
As shown in FIGS. 4 to 7, the tubular connecting portion 60 of the female terminal 31 according to the non-limiting embodiment of the present disclosure may be configured to include or define a straight hole having a longitudinal axis (arrow Z in figures) to receive the columnar connecting portion 201 of the male terminal 200. For example, the tubular connecting portion 60 may include the plurality of divided tubular portions 52 each including a first straight groove (inner surface 54) having a first groove length and the single tubular portion 41 including a second straight groove (inner surface 42) having a second groove length longer than the first groove length. As shown in FIG. 7, the straight hole of the tubular connecting portion 60 may be defined between a subset of a plurality of the first straight grooves (inner surfaces 54) of the plurality of divided tubular portions 52 and the second straight groove (inner surface 42) provided in the single tubular portion 41.
As shown in FIG. 9, the plurality of protrusions 56 (plurality of projecting tips 56A) of the female terminal 31 of the non-limiting embodiment may be provided at a single first angular position or a first circumferential position around the longitudinal axis (Z) of the tubular connecting portion 60 of the female terminal 31 (see FIG. 7). The plurality of protrusions 56 (plurality of projecting tips 56A) may be linearly aligned along the longitudinal axis (Z) of the tubular connecting portion 60 of the female terminal 31. A subset of the plurality of protrusions 56 (plurality of projecting tips 56A) may be referred to as a first subset of pressure positions discrete in the axial direction and configured to pressurize the side surface of the columnar connecting portion 201 of the male terminal 200 radially inwardly at the single first angular position.
As shown in FIGS. 7 and 8, the plurality of linear contact portions 43 of the female terminal 31 of the non-limiting embodiment may be provided at a plurality of second angular positions or second circumferential positions around the longitudinal axis (Z) of the tubular connecting portion 60 of the female terminal 31 (see FIG. 7). Each of the plurality of linear contact portions 43 may extend straight without any interruption along the longitudinal axis (Z) of the tubular connecting portion 60 of the female terminal 31. A subset of the plurality of linear contact portions 43 may be referred to as a subset of linear seat portions discrete in the circumferential direction and configured to support the side surface of the columnar connecting portion 201 of the male terminal 200 at the plurality of second angular positions. The subset of the plurality of linear contact portions 43 may be referred to as a second subset of pressure positions discrete in the circumferential direction and configured to pressurize the side surface of the columnar connecting portion 201 of the male terminal 200 radially inwardly at the plurality of second angular positions.
The embodiment disclosed this time should be considered illustrative in all aspects, rather than restrictive. The scope of the present invention is represented not by the above meaning, but by claims and is intended to include all changes in the scope of claims and in the meaning and scope of equivalents.

### LIST OF REFERENCE NUMERALS

20 . . . wire, 21 . . . core wire, 22 . . . insulation coating, 30 . . . housing, 31 . . . female terminal, 32 . . . wire connecting portion (second connecting portion), 33 terminal connecting portion, 40 . . . peripheral wall (second peripheral wall), 41 . . . tubular portion (second tubular portion), 42 . . . inner surface (second inner surface), 43 . . . linear contact portion, 50 . . . peripheral wall (first peripheral wall), 51 . . . tubular portion (first tubular portion), 52 . . . divided tubular portion, 53 . . . slit, 54 . . . inner surface (first inner surface), 55 . . . dent portion, 56 . . . protrusion, 56A . . . projecting tip, 57 . . . divided portion, 58 . . . convex portion, 59 . . . concave portion, 60 . . . tubular connecting portion (first connecting portion), 61, 62 . . . guiding portion, 70 . . . coupling portion, 71, 72 . . . extending portion, 73 . . . folded portion, 80 . . . projecting portion, 81 . . . projecting base portion, 82 . . . projection, 90 . . . winding/pressing portion, 91 . . . extending portion, 92 . . . folded portion, 93 . . . pressing portion, 94 . . . facing surface, 95 . . . through hole, 96 engagement surface, 100 . . . protecting portion, 101 . . . extending portion, 102 . . . protection wall, 110 . . . housing, 111 . . . opening, 112 . . . peripheral wall, 113 . . . tube portion, 114 . . . insertion hole, 120 . . . retainer, 121 . . . body portion, 122 . . . restricting portion, 123 . . . insertion hole, 124 . . . bottom wall, 125, 126 . . . side wall, 127 . . . engagement wall, 200 . . . male terminal, 201 . . . columnar connecting portion, W1 wiring harness, C1 . . . connector, A1 . . . center, L1 . . . first distance, P1 . . . first projection amount, P2 . . . second projection amount, X1 . . . first direction, X2 . . . first opposite direction, Y1 . . . second direction, Y2 . . . second opposite direction, Z1 . . . third direction, Z2 . . . third opposite direction

1. A female terminal, comprising:
a first peripheral wall having a first tubular portion;
a second peripheral wall having a second tubular portion facing the first tubular portion; and
a tubular connecting portion composed of the first tubular portion and the second tubular portion,
the tubular connecting portion being a first connecting portion, a columnar connecting portion of a male terminal being inserted into the first connecting portion, the first connecting portion being electrically connected to the columnar connecting portion,
the first tubular portion including a plurality of divided tubular portions divided in an axial direction of the tubular connecting portion, and
each of the plurality of divided tubular portions including a first inner surface facing the second tubular portion and a protrusion arcuately projecting radially inwardly of the tubular portion from the first inner surface in a cross-section.

2. The female terminal of claim 1, wherein:
the plurality of divided tubular portions are two divided tubular portions,
the first tubular portion includes a slit dividing the two divided tubular portions, and
the slit is provided at a center position of the tubular portion in the axial direction.

3. The female terminal of claim 2, wherein:
the first peripheral wall is formed into a strip shape extending along a first direction,
the second peripheral wall is formed into a strip shape extending along the first direction,
the first inner surface is provided to face the second tubular portion in a second direction intersecting the first direction,
the axial direction of the tubular connecting portion extends along a third direction intersecting both the first direction and the second direction,
the slit extends along a first opposite direction opposite to the first direction from an end surface in the first direction of the first peripheral wall,
the slit penetrates through the first peripheral wall in both the second direction and a second opposite direction opposite to the second opposite direction, and
the slit is open in the first direction.

4. The female terminal of claim 3, wherein the two divided tubular portions are plane-symmetrically formed with respect to a virtual plane including a center of the slit in the third direction and extending in both the first direction and the first opposite direction.

5. The female terminal of claim 4, wherein a projecting tip of the protrusion of each of the two divided tubular portions is provided at a position separated from a center of the tubular connecting portion in the axial direction by a first distance in the axial direction.

6. The female terminal of claim 1, wherein:
the second tubular portion includes a second inner surface facing the first inner surface and a plurality of linear contact portions projecting radially inwardly of the tubular connecting portion from the second inner surface,
the plurality of linear contact portions are provided at positions separated from each other in a circumferential direction of the tubular connecting portion, and
each of the plurality of linear contact portions extends along the axial direction.

7. The female terminal of claim 6, further comprising a winding/pressing portion for limiting a separation distance between the first inner surface and the second inner surface, wherein:
the winding/pressing portion is integrally formed to the second peripheral wall, and
the winding/pressing portion is folded from the second peripheral wall while embracing an end edge of the first peripheral wall inside, and held in contact with an outer surface of the first peripheral wall.

8. The female terminal of claim 7, further comprising a coupling portion coupling the first peripheral wall and the second peripheral wall, wherein:
the coupling portion is integrally formed to the first peripheral wall and integrally formed to the second peripheral wall.

9. The female terminal of claim 7, wherein:
the first peripheral wall is formed into a strip shape extending along a first direction,
the second peripheral wall is formed into a strip shape extending along the first direction,
the first inner surface is provided to face the second tubular portion in a second direction intersecting the first direction,
the female terminal further comprises a protecting portion provided on an end part in the first direction of the second peripheral wall,
the protecting portion is integrally formed to the second peripheral wall,
the protecting portion is formed to be folded from the end part in the first direction of the second peripheral wall while arranging an end part in the first direction of the first peripheral wall inside,
the protecting portion includes a protection wall provided to face the end part in the first direction of the first peripheral wall in the second direction, and
the protection wall is provided away from the end part in the first direction of the first peripheral wall.

10. The female terminal of claim 9, wherein:
the winding/pressing portion is provided on an end part in a first opposite direction opposite to the first direction, out of the second peripheral wall, and
the tubular connecting portion is provided at an intermediate position between the winding/pressing portion and the protecting portion in the first direction.

11. The female terminal of claim 9, further comprising a wire connecting portion provided on an end part in a first opposite direction opposite to the first direction, out of the second peripheral wall, wherein:
the wire connecting portion is a second connecting portion to be electrically connected to a wire,
the wire connecting portion is integrally formed to the second peripheral wall, and
the wire connecting portion extends in the first opposite direction from the end part in the first opposite direction of the second peripheral wall.

12. A connector, comprising:
the female terminal of claim 1; and
a housing for accommodating the female terminal inside.
